(19) United States
(12) Patent Application Publication
(10) Pub. No.: US 2003/0092596 A1
(43) Pub. Date: May 15, 2003

(54) Polymer products

(75) Inventors: Simon Marinus Veerman, Vlaardingen (NL); Frank J.C. Wilschut, Rotterdam (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/196,811

(22) Filed: Jul. 17, 2002

(30) Foreign Application Priority Data
Jul. 24, 2001 (GB) 011 8027.2

(51) Int. Cl. C11D 17/00

(52) U.S. Cl. 510/475; 510/447

(57) ABSTRACT

A solid water soluble polymer having dispersed therein, at least one cleaning composition auxiliary.

### FIELD OF THE INVENTION

This invention relates to water soluble products which are useful in household cleaning operations, especially laundry cleaning.

### BACKGROUND OF THE INVENTION

Recently, there has been a trend in formulation of laundry and other home cleaning products, to provide them in unit dose form such as tablets. The unit dose concept has in most recent times, been extended to liquid unit dose products in which the active ingredients are incorporated as a non-aqueous liquid composition inside a capsule formed of a water-soluble polymer film. This formulation type poses its own special technical problems.

First, formulating a laundry detergenr product in liquid form, especiall in non-aqueous liquid form, has limitations towards solubility of ingredients in the porduct and stability thereof. Further, the need to formulate a concentrated efficacious composition in a non-aqueous liquid form, exacerbates problems which are often found in laundry cleaning products, whereby individual components of the composition interact adversely with one another.

The present invention provides a novel way of avoiding the aforementioned problems and extends to completely novel concepts of product form. This involves dispersing one or more auxiliary agents in a solid water-soluble polymer.

WO-A-97/02003 describes a water-soluble film containing amethocaine. This film has the purpose of anaesthetize intact skin.

WO-A-00/7518 describes a strip containing a bleaching agent that is to be placed on teeth for whitening.

U.S. Pat. No. 5,433,884 describes biopolymer granules dispersed in non-aqueous liquid.

U.S. Pat. No. 5,480,575 describes protecting reactive or sensitive adjuncts, in particular bleach catalysts, by dissolving them in biopolymer and granulating the biopolymer thereafter.

U.S. Pat. No. 4,115,292 describes enzyme containing polyvinyl alcohol (PVA) strips for dishwashing applications.

U.S. Pat. No. 4,481,326 describes addition of polyvinylpyrrolidone (PVP) to PVA film to increase stability and resilience.

### SUMMARY OF THE INVENTION

A first aspect of the present invention provides a solid water soluble polymer having dispersed therein, at least one cleaning composition auxiliary.

A proviso is that the invention does not extend to water soluble polymer resins in the form of a film or a film cut into strips, wherein the only auxiliary dispersed therein comprises one or more enzymes, as disclosed in U.S. Pat. No. 4,115,292.

For convenience, hereinbelow, the solid water soluble polymer will sometimes be referred to simply as the “polymer”. Similarly, the solid cleaning composition auxiliary will sometimes be called simply, the “auxiliary”. Since a mixture of such polymers and/or a mixture of such auxiliaries may optionally be present, as the context permits, the singular should be taken to encompass the plural, and vice versa.

For the avoidance of doubt, the term “cleaning composition auxiliary” means an agent which is a material which can be as an auxiliary component in cleaning compositions, i.e. it is often incorporated in such composition at relatively low concentrations. It does not mean that the component necessarily has cleaning efficacy in itself.

### DETAILED DESCRIPTION OF THE INVENTION

### I. Product Form

The solid water soluble polymer of the present invention may be presented in one of a number of different forms.

In one especially preferred embodiment, this polymer is provided in the form of a film or sheet. Such a film or sheet may for example be formed into a capsule containing a cleaning composition. Such a cleaning composition preferably contains one or more primary cleaning composition ingredients so that one or more auxiliary or minor components are delivered by virtue of being dispersed in the polymer of the film itself. However, also within the ambit of the invention is a piece of polymer per se, for example presented as a piece of film or sheet of the solid water soluble polymer, in which one or more cleaning composition auxiliaries are dispersed. These may for example, be added separately to a hand or machine wash liquor. For example, it is common in some parts of the world for bleach ingredients to be dosed separately from the main wash product (e.g. liquid or powder).

In the case of encapsulation in such a film or sheet polymer material, the encapsulated cleaning composition may for example be in solid form, e.g. as a tablet or powder. However, an especially preferred class of embodiments is where the cleaning composition so contained, is a substantially non-aqueous liquid cleaning composition.

Another form of product presentation is where the solid water soluble polymer is itself in the form of a solid block or tablet. One product form is the block or tablet of the polymer per se, having one or more detergent composition auxiliaries dispersed therein. However, another block or tablet product form is where, as well as one or more detergent composition auxiliaries, it is preferred that at least one solid cleaning composition primary ingredient, is also included as a solid material dispersed within the block or tablet. Then at least one primary ingredient may be dispersed as a dispersed as a powder within the tablet or block, or present as a tablet encased within a shell of the polymer. It is also possible to admix one or more additional auxiliaries in composition with the primary ingredient.

Such primary ingredients may for example, be selected from surfactants, detergency builders and bleaches. As used herein, the term “surfactant” includes both synthetic surfactant materials, as well as soaps. Similarly, the term “bleach” includes materials which are bleaches per se, as well as bleach system which comprise two or more components which react in the wash to form a bleach species, such as a peroxygen bleach together with a bleach activator. However, within the terminology of the present application, bleach catalysts, necessarily also having a separate bleach present, fall into the category of “detergent composition auxiliary”. As will be explained herein and below, these form an especially preferred variant or set of embodiments of the present invention, whether the solid polymer film is in the form of a film, sheet, block, tablet or in any other product form.

The term “cleaning composition” relates to a composition for any household or industrial cleaning application, for example pre-treatment/prewash, cleaning or main wash, bleaching, or rinsing, e.g., in a laundry, hard surface (e.g. kitchens, bathroom or lavatory) or warewashing cleaning operation. It will be appreciated that although in many of these applications a surfactant may be present as a primary ingredient, in some applications it is optional or undesirable.

In the case of the block or tablet presentation of the solid water soluble polymer, it is also possible to include in such block or tablet, a decorative member, e.g. presenting a logo or other aesthetically appealing feature. Such a decorative member may for example be fond of a plastics material embossed or printed.

Dosage

From the foregoing, it will be appreciated that suitable product forms include pieces of the polymer per se, e.g. film, sheet, tablet or block, as well as encapsulated powder or liquid cleaning compositions in which the polymer in sheet or film form constitutes at least part of the capsule. Yet again, one or more primary cleaning agents may be within the body of a tablet or block of the polymer, either as a dispersed powder or an encased tablet. In all cases, the polymer has at least one cleaning composition auxiliary dispersed therein.

Thus, the amount of total cleaning composition auxiliary components within the polymer may vary considerably, depending on both the product form and the particular auxiliary in question. Referred amounts of different classes of cleaning composition auxiliary will be given below in the section of the description where those particular materials are discussed in detail. However, as a general rule, the total amount of solid cleaning composition auxiliary may for example vary from 0.01% to 50%, preferably from 0.04% to 40%, more preferably from 0.4% to 25% by weight of the total of the water soluble polymer plus auxiliary component(s).

### II. The Water Soluble Polymer

As used herein, the term “water soluble polymer” refers to a polymer which dissolves and/dispensers completely in water within 5 minutes with agitation, e.g. by means of hand, stick or other stirrer or under the action of a mechanical washing machine and at a relevant temperature. A “relevant temperature” is one at which the consumer will need to dissolve or disperse the polymer component at the beginning of, or during a cleaning process. A polymer is to be regarded as dissolving or dispersing at a “relevant temperature” if it does so under the aforementioned conditions at a temperature anywhere in the range of from 20° C. to 60° C. Preferred water soluble polymers are those capable of being cast into a film or solid mass and may for example as described in Davidson and Sittig, Water-Soluble Resins, Van Nostrand Reinhold Company, New York (1968), herein incorporated by reference. The water-soluble polymer should have proper characteristics, such as strength and pliability, to permit machine handling. Preferred water-soluble resins include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, hydroxypropylmethyl cellulose, hydroxybutylmethyl cellulose, ethyl methylcellulose, hydroxyethyl methylcellulose. Lower molecular weight water-soluble, polyvinyl alcohol film-forming resins are preferred.

Generally, preferred water-soluble, polyvinyl alcohol film-forming polymers should have relatively low average molecular weight and low levels of hydrolysis in water. Polyvinyl alcohols preferred for use therein have an average molecular weight between 1,000 and 300,000, preferably between 2,000 and 100,000, most preferably between 2,000 and 75,000. Hydrolysis, or alcoholysis, is defined as the percent completion of the reaction where acetate groups on the resin are substituted with hydroxyl, —OH, groups, A hydrolysis range of from 60-99% of polyvinyl alcohol film-forming resin is preferred, while a more preferred range of hydrolysis is from about 70-90% for water-soluble, polyvinyl alcohol film-forming resins. The most preferred range of hydrolysis is 80-88%. As used in this application, the term “polyvinyl alcohol” includes polyvinyl acetate compounds with levels of hydroloysis disclosed herein. The film should be formulated so as to substantially completely dissolve in 130° F. water with agitation within about five minutes, preferably within about 3 minutes in 100° F. water with agitation, and most preferably within about 1 minute in 100° F. water with agitation.

All of the above polymers include the aforementioned polymer classes whether as single polymers or as copolymers formed of monomer units or as copolymers formed of monomer units derived from the specified class or as copolymers wherein those monomer units are copolymerised with one or more comonomer units.

An especially preferred plastics film is a polyvinyl alcohol film, especially one made of a polyvinyl alcohol copolymer having a comonomer having a carboxylate function.

PVA can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVA films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

PVA is especially useful for forming a film, both for use per se with solids dispersed therein and for encapsulating a cleaning composition suitable PVOH films of this type are commercially available and described, for example, in EP-B-0291198. PVOH films for use in a package according to the invention can be made by the copolymerisation of vinyl acetate and a carboxylate-containing monomer (for example acrylic, maleic or itaconic acid or acid ester), followed by partial (for example up to about 90%) hydrolysis with sodium hydroxide.

Polyvinylpyrrolidone, another preferred polymer for use in the articles of the present invention, may be cast from a variety of solvents to produce films which are clear, glossy, and reasonably hard at low humidities. These polyvinylpyrrolidone films exhibit excellent adhesion to a wide variety of surfaces, including glass, metals, and plastics. Unmodified films of polyvinylpyrrolidone are hygroscopic in character. Dry polyvinylpyrrolidone film has a density of 1.25 and a refractive index of 1.53. Tackiness at higher humidities may be minimized by incorporating compatible, water-insensitive modifiers into the polyvinylpyrrolidone film, such as 10% of an aryl-sulfonamide-formaldehyde resin.

Preferred water-soluble films may also be prepared from polyethylene oxide resins by standard calendering, molding, casting, extrusion, and other conventional techniques. The polyethylene oxide films may be clear or opaque, and are inherently flexible, tough, and resistant to most oils and greases. These polyethylene oxide resin films provide better solubility than other water-soluble plastics without sacrificing strength or toughness. The excellent ability to lay flat, stiffness, and sealability of water-soluble polyethylene oxide films make for good machine handling characteristics.

### III. Manufacturing Processes

(a) Preparation of the Water Soluble Polymer

Methods of manufacturing water soluble polymers such as polyvinl alcohol polymers or copolymers containing same, as well as polyvinyl pyrrolidone and polyethylene oxide polymers are well known. Many examples are available commercially.

PVOH polymers can be prepared by polymerisation of polyvinyl acetate followed by hydrolysis of the acetic function to yield the alcohol (polymerisation of vinyl alcohol cannot be used because of keto/enol tauterism). Polyvinyl acetate is routinely manufactured by free radical polymerisation with an azo catalyst, followed by an alkaline hydrolysis step to liberate the acetic groups. The polymer (often referred to as the “resin”) mix then goes through purification stages to remove Na acetate, solvent and the catalyst.

The features of the polymer which have greatest bearing on final film properties are the molecular weight (mean and number ), the linearity of the chains and the degree of hydrolysis of the acetic ester. The water solubility of homo-polymer films is largely controlled by the extent of the acetate hydrolysis, this governing the structural order of the polymer chain arrays and the extent of hydrogen bonding. Complete hydrolysis gives extensive order and hydrogen bonding in the polymer. Too little hydrolysis makes the polymer chains too hydrophobic because of the acetic methyl groups which again reduces water solubility. For optimal solubility of homo-polymer films, the degree of hydrolysis of the acetic groups is from about 80% to 95%.

It should be noted that whilst these polymer films are not strictly homogeneous in that they contain different functional groups along the polymer chain (acetic or hydroxyl) they are still classified as homo-polymers within the industry because the original polymerisation is with one monomer, namely vinyl acetate.

An alternative route to disrupt molecular order and hence increase water solubility is to introduce co-monomers in addition to polyvinyl acetate during polymerisation. An example of this is to copolymerise with a small molar percentage of a monomer containing a carboxylic function such as methyl acrylate.

Other common co-monomers include vinyl monomers with neutralised sulphonate (AMPS) or amide groups (NVA).

Films from routes such as this where two monomers are utilised are referred to herein as copolymer films

The polymer preferably incorporates a plasticiser. The plasticiser system influences the way the polymer chains react to external factors such as compression and extensional forces, temperature and mechanical shock by controlling the way that the chains distort/realign as a consequences of these intrusions and their propensity to revert or recover to their former state. The key feature of plasticisers is that they are highly compatible with the film, being hydrophilic in nature and with —OH groups in common with the ˜CH2—CH(OH)—CH2—CH(OH)˜ polymer chain.

Their mode of functionality is to introduce short chain hydrogen bonding with the chain hydroxyl groups and this weaken adjacent chain interactions which inhibits swelling of the aggregate polymer mass—the first stage of film dissolution. Water itself is a suitable plasticizer for PVOH films but other common plasticizers include:

Polyhydroxy Compounds, e.g. Glycerol, diglycerol, trimethylolpropane, diethylene glycol, triethylene glycol, dipropylene glycol

Starches e.g. starch ether, esterificated starch, oxidized starch and starches from potato, tapioca and wheat

Cellulosics/carbohydrates, e.g. amylopectin, dextrin carboxymethylcelluose and pectin.

Other suitable additives include include silica, SiO₂, talc, starch, amine oxides and cationics for band release and for anti blocking and silicone to assist de aeration of the casting solution.

(b) Incorporating the Dispersed Auxiliary

If the water-soluble polymer is used to create a film, a solid auxiliary may be mixed in with the slurry containing (partly) dissolved or dispersed polymer or monomer before drawing or casting (as described further hereinbelow) or it may be dispersed in the drawn or cast film before solidification.

Where a block or tablet includes dispersed powdered or granulated dispersed solid cleaning auxiliary, this is conveniently dispersed in the bulk of the liquid monomer or polymer before or after casting.

Where a block or tablet includes the cleaning composition auxiliary in compacted form the liquid monomer or polymer may be poured over the compacted mass or the compacted mass may be sprayed with the liquid or it may be dipped in the liquid.

Liquid auxilaries may be incorporated in the same way but must be capable of stable dissolution or dispersion in the polymer in question. This compatibility may be determined by simple trial and error for given materials.

(c) Polymer Films and Capsules made Therefrom

One suitable method of creating the film is thermal blow extrusion, where the polymer in a mixture with the plasticizer/additives mix is thermally extruded through a circular extrusion head and blown to form an elongated bubble. The flattened bubble is taken up and over a series of rollers before returning to ground level and trimmed along both edges of the film tube to produce two webs of single thickness film which are subsequently separated and wound into rolls. The process is less preferred because of high incidences of imperfections caused by hard gels in the melts of PVOH based formulations, also gauge control (thickness) on this process is imprecise.

Another film forming technique is aqueous casting, which is especially useful, used for producing higher quality films, where the film raw materials are dissolved in water, allowed to stand/deaerate before being pumped through filters and extruded onto a belt or drum prior and oven drying to achieve the desired film water content.

PVOH Films are commercially available in thickness from 25 to 100 microns (more commonly 25 to 50 microns). For a liquid unit dose product films which, even after thermoforming, have a minimum thickness of 45 micron are especially preferred, e.g. a 75 microns thermoforming film.

Film Lamination

Film laminates can be produced by combining two thinner webs with PVOH adhesive. This is an appealing approach where liquid containment is required because for there to be leakage through the film there would have to be a hole lined up between the two sides of the laminate for liquid to leak through. However in practice there are problems in that even where the marriage of the two surfaces is perfect—the higher molecular weight and cross-linked PVOH useful for adhesion has lower water solubility than base film and may be left as a residue after the dissolution of the main film is complete.

Encapsulation

When such water soluble films are used to encapsulate a cleaning composition, the encapsulation technique is preferably horizontal form-fill-seal (HFFS) or vertical form-fill-seal (VFFS).

Horizontal Form-fill-seal

Water soluble polymer packages of the invention can be made according to any of the methods horizontal form-fill-seal described in any of WO-A-00/55044, WO-A-00/55045, WO-A-00/55046, WO-A-00/55068, WO-A-00/55069 and WO-A-00/55415.

By way of example, a thermoforming process is now described where a number of packages according to the invention are produced from two sheets of water soluble material. In this regard recesses are formed in the film sheet using a forming die having a plurality of cavities with dimensions corresponding generally to the dimensions of the packages to be produced. Further, a single heating plate is used for thermoforming the film for all the cavities, and in the same way a single sealing plate is described.

A first sheet of polyvinyl alcohol film is drawn over a forming die so that the film is placed over the plurality of forming cavities in the die. In this example each cavity is generally dome shape having a round edge, the edges of the cavities further being radiussed to remove any sharp edges which might damage the film during the forming or sealing steps of the process. Each cavity further includes a raised surrounding flange. In order to maximise package strength; the film is delivered to the forming die in a crease free form and with minimum tension. In the forming step, the film is heated to 100 to 120° C., preferably approximately 110° C., for up to 5 seconds, preferably approximately 700 micro seconds. A heating plate is used to heat the film, which plate is positioned to superpose the forming die. During this preheating step, a vacuum of 0.5 bar is pulled through the pre-heating plate to ensure intimate contact between the film and the pre-heating plate, this intimate contact ensuring that the film is heated evenly and uniformly (the extent of the vacuum is dependant of the thermoforming conditions and the type of film used, however in the present context a vacuum of less than 0.6 bar was found to be suitable) Non-uniform heating results in a formed package having weak spots. In addition to the vacuum, it is possible to blow air against the film to force it into intimate contact with the preheating plate.

The thermoformed film is moulded into the cavities blowing the film off the heating plate and/or by sucking the film into the cavities thus forming a plurality of recesses in the film which, once formed, are retained in their thermoformed orientation by the application of a vacuum through the walls of the cavities. This vacuum is maintained at least until the packages are sealed. Once the recesses are formed and held in position by the vacuum, a liquid composition according to the invention is added to each of the recesses. A second sheet of polyvinyl alcohol film is then superposed on the first sheet across the filled recesses and heat-sealed thereto using a sealing plate. In this case the heat sealing plate, which is generally flat, operates at a temperature of about 140 to 160° C., and contacts the films for 1 to 2 seconds and with a force of 8 to 30 kg/cm², preferably 10 to 20 kg/cm². The raised flanges surrounding each cavity ensure that the films are sealed together along the flange to form a continuous seal. The radiussed edge of each cavity is at least partly formed by a resiliently deformable material, such as for example silicone rubber. This results in reduced force being applied at the inner edge of the sealing flange to avoid heat/pressure damage to the film.

Once sealed, the packages formed are separated from the web of sheet film using cutting means. At this stage it is possible to release the vacuum on the die, and eject the formed packages from the forming die. In this way the packages are formed, filled and sealed while nesting in the forming die. In addition they may be cut while in the forming die as well.

During the forming, filling and sealing steps of the process, the relative humidity of the atmosphere is controlled to ca. 50% humidity. This is done to maintain the heat sealing characteristics of the film. When handling thinner films, it may be necessary to reduce the relative humidity to ensure that the films have a relatively low degree of plasticisation and are therefore stiffer and easier to handle.

Vertical Form-Fill-Seal

In the vertical form-fill-seal (VFFS) technique, a continuous tube of flexible plastics film is extruded. It is sealed, preferably by heat or ultrasonic sealing, at the bottom, filled with the liquid composition, sealed again above the liquid film and then removed from the continuous tube, e.g. by cutting.

(d) Blocks and Tablets

Tableting entails compaction of a particulate composition.

A variety of tableting machinery is known, and can be used. Generally it will function by stamping a quantity of the particulate composition which is confined in a die.

Tableting machinery able to carry out such operations is known. For example, suitable tablet presses are available from Fette and from Korsch.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also.

It is known to make tablets using microwave radiation. WO 96/06156 mentions that hydrated materials are useful in this special circumstance to cause sintering.

For the present invention, if any heat is supplied, it is envisaged that this will be supplied conventionally, such as by passing the particulate composition through an oven, rather than by any application of microwave energy.

The size of a tablet will suitably range from 10 to 160 grams (gm), preferably from 15 to 60 gm, depending on the conditions of intended use, and whether the tablet represents a dose for an average load in a fabric washing or a fractional part of such a dose. The tablets may be of any shape. However, for ease of packaging they are preferably blocks of substantially uniform cross-section, such as cylinders or cuboids. The overall density of a tablet is preferably 1040 or 1050 gm/litre, better 1100 gm/litre, up to 1300 or 1350 gm/litre or even more. The tablet density may well lie in a range up to no more than 1250 or even 1200 gm/litre.

While the starting particulate composition may in principle have any bulk density, the present invention is especially relevant to tablets made by compacting powders of relatively high bulk density, because of their greater tendency to exhibit disintegration and dispersion problems. Such tablets have the advantage that, as compared with a tablet derived from a low bulk density powder, a given dose of composition can be presented as a smaller tablet.

Thus the starting particulate composition may suitably have a bulk density of at least 400 g/litre, preferably at least 500 g/litre, and advantageously at least 700 g/litre. Granular detergent compositions of high bulk density prepared by granulation and densification in a high-speed mixer/granulator, as described and claimed in EP 340013A (Unilever), EP 352135A (Unilever), and EP 425277A (Unilever), or by the continuous granulation/densification processes described and claimed in EP 367339A (Unilever) and EP 390251A (Unilever), are inherently suitable for use in the present invention.

Tablets in which the rinse composition is held in a central cavity (the body of the tablet) containing a wash composition may be formed using an appropriately shaped die.

As indicated above, the liquid monomer or polymer may be sprayed onto or poured over the block or tablet or the latter may be coated by dipping.

### IV. Detergent Composition Auxiliaries

In general, the term “cleaning composition auxiliary” may be any component which would normally be included in a regular detergent composition in relatively low amounts, e.g. in such a normal composition in amounts up to 5%, up to 2.5%, or just up to 1% by weight of that total composition. A non-limiting list of such auxiliaries includes bleach catalysts, bleach activators, UV absorbers such as fluorescers and photofading inhibitors, for example sunscreens/UV inhibitors and/or anti-oxidants, materials for inhibiting fibre damage and/or for colour care and/or for crease reduction and/or for ease of ironing, enzymes, perfumes, sequestrants, buffer agents, effervescent agents, as well as fungicides, insect repellents and/or insecticides. A single one or a mixture of two or more of such materials may be included.

(a) Bleach Catalysts

In especially preferred class of detergent composition auxiliary comprises the bleach catalysts.

When present, the total amount of bleach catalyst is preferably from 0.01%, eg. 0.04% to 40%, more preferably from 0.4% to 25% by weight of total bleach catalyst plus the polymer.

Bleach catalysts include those materials which catalyse bleaching be a bleach species, whether included as a bleach species per se, or a reactive bleach system such as a peroxygen bleach together with a bleach activator. However, in recent times, considerable interest has been shown in those bleach catalysts which function by catalysing bleach activity by atmospheric oxygen, e.g., from the air or from air dissolved in the wash liquor.

The bleach catalyst per se may be selected from a wide range of transition metal complexes of organic molecules (ligands). Suitable organic molecules (ligands) for forming complexes and complexes thereof are found, for example in: GB 9906474.3; GB 9907714.1; GB 98309168.7, GB 98309169.5; GB 9027415.0 and GB 9907713.3; DE 19755493; EP 999050; WO-A-9534628; EP-A-458379; EP 0909809; U.S. Pat. No. 4,728,455; WO-A-98/39098; WO-A-98/39406, WO 9748787, WO 0029537; WO 0052124, and WO0060045 the complexes and organic molecule (ligand) precursors of which are herein incorporated by reference.

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

The transition metal complex preferably is of the general formula (AI):

[MₐLₖXₙ]Yₘ

in which:

M represents a metal selected from Mn(II)-(III)-(IV)-(V), Cu(I)-(II)-(III), Fe (II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI), preferably from Fe(II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

n represents zero or an integer from 1 to 10;

m represents zero or an integer from 1 to 20.

Preferably, the complex is an iron complex comprising the ligand N,N-bis(pyridin-2-yl-methyl)-1,1-bis(pyridin-2-yl)-1-aminoethane. Suitable classes of ligands are described below:

(A) Ligands of the general formula (IA):

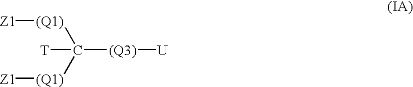

Z1 groups independently represent a coordinating group selected from hydroxy, amino, —NHR or —N(R)₂ (wherein R=C₁₋₆-alkyl), carboxylate, amido, —NH—C(NH)NH₂, hydroxyphenyl, a heterocyclic ring optionally substituted by one or more functional groups E or a heteroaromatic ring optionally substituted by one or more functional groups E, the heteroaromatic ring being selected from pyridine, pyrimidine, pyrazine, pyrazole, imidazole, benzimidazole, quinoline, quinoxaline, triazole, isoquinoline, carbazole, indole, isoindole, oxazole and thiazole;

Q1 and Q3 independently represent a group of the formula:

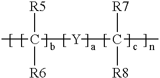

5≧a+b+c>1; a=0-5; b=0-5; c=0-5; n=0 or 1 (preferably n=0);

Y independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I;

T represents a non-coordinated group selected from hydrogen, hydroxyl, halogen, —R and —OR, wherein R represents alkyl, alkenyl, cycloalkyl, heterocycloalkyl, aryl, arylalkyl, heteroaryl or a carbonyl derivative group, R being optionally substituted by one or more functional groups E (preferably T═ —H, —OH, methyl, methoxy or benzyl);

U represents either a non-coordinated group T independently defined as above or a coordinating group of the general formula (IIA), (IIIA) or (IVA):

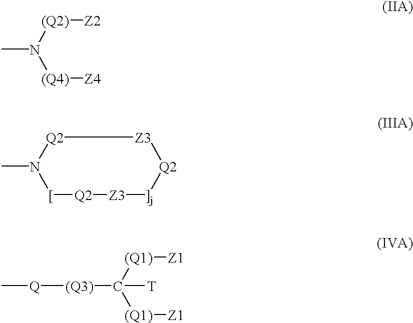

Q2 and Q4 are independently defined as for Q1 and Q3;

Q represents —N(T)— (wherein T is independently defined as above), or an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;

Z2 is independently defined as for Z1;

Z3 groups independently represent —N(T)— (wherein T is independently defined as above);

Z4 represents a coordinating or non-coordinating group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E, or Z4 represents a group of the general formula (IIAa):

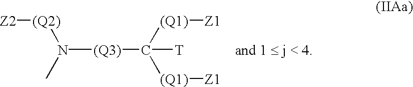

Preferably, Z1, Z2 and Z4 independently represent an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. More preferably, Z1, Z2 and Z4 independently represent groups selected from optionally substituted pyridin-2-yl, optionally substituted imidazol-2-yl, optionally substituted imidazol-4-yl, optionally substituted pyrazol-1-yl, and optionally substituted quinolin-2-yl. Most preferred is that Z1, Z2 and Z4 each represent optionally substituted pyridin-2-yl.

The groups Z1, Z2 and Z4 if substituted, are preferably substituted by a group selected from C₁₋₄-alkyl, aryl, arylalkyl, heteroaryl, methoxy, hydroxy, nitro, amino, carboxyl, halo, and carbonyl. Preferred is that Z1, Z2 and Z4 are each substituted by a methyl group. Also, we prefer that the Z1 groups represent identical groups.

Each Q1 preferably represents a covalent bond or C1-C4-alkylene, more preferably a covalent bond, methylene or ethylene, most preferably a covalent bond.

Group Q preferably represents a covalent bond or C1-C4-alkylene, more preferably a covalent bond. The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

Non-coordinated group T preferably represents hydrogen, hydroxy, methyl, ethyl, benzyl, or methoxy.

In one aspect, the group U in formula (IA) represents a coordinating group of the general formula (IIA):

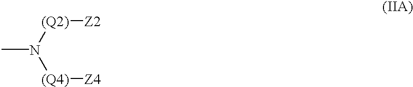

According to this aspect, it is preferred that Z2 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, more preferably optionally substituted pyridin-2-yl or optionally substituted benzimidazol-2-yl.

It is also preferred, in this aspect, that Z4 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, more preferably optionally substituted pyridin-2-yl, or an non-coordinating group selected from hydrogen, hydroxy, alkoxy, alkyl, alkenyl, cycloalkyl, aryl, or benzyl.

In preferred embodiments of this aspect, the ligand is selected from:

1,1-bis(pyridin-2-yl)-N-methyl-N-(pyridin-2-ylmethyl)methylamine;

1,1-bis(pyridin-2-yl)-N,N-bis(6-methyl-pyridin-2-ylmethyl)methylamine;

1,1-bis(pyridin-2-yl)-N,N-bis(5-carboxymethyl-pyridin-2-ylmethyl)methylamine;

1,1-bis(pyridin-2-yl)-1-benzyl-N,N-bis(pyridin-2-ylmethyl)methylamine; and

1,1-bis(pyridin-2yl)-N,N-bis(benzimidazol-2-ylmethyl)methylamine.

In a variant of this aspect, the group Z4 in formula (IIA) represents a group of the general formula (IIAa):

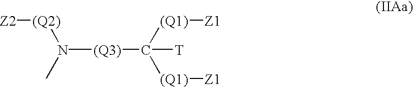

In this variant, Q4 preferably represents optionally substituted alkylene, preferably —CH₂—CHOH—CH₂— or —CH₂—CH₂—CH₂—. In a preferred embodiment of this variant, the ligand is:

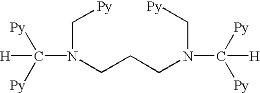

wherein -Py represents pyridin-2-yl.

In another aspect, the group U in formula (IA) represents a coordinating group of the general formula (IIIA):

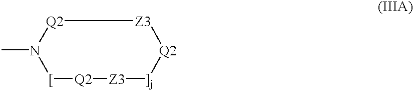

wherein j is 1 or 2, preferably 1.

According to this aspect, each Q2 preferably represents —(CH₂)ₙ- (n=2-4), and each Z3 preferably represents —N(R)— wherein R=—H or C₁₋₄-alkyl, preferably methyl.

In preferred embodiments of this aspect, the ligand is selected from:

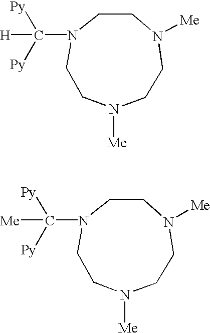

wherein -Py represents pyridin-2-yl.

In yet another aspect, the group U in formula (IA) represents a coordinating group of the general formula (IVA):

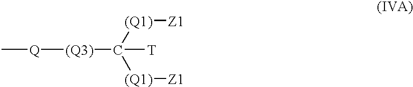

In this aspect, Q preferably represents —N(T)— (wherein T=—H, methyl, or benzyl) or pyridin-diyl.

In preferred embodiments of this aspect, the ligand is selected from:

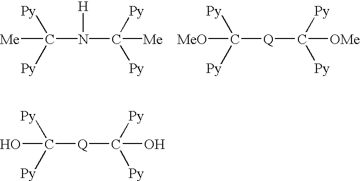

wherein -Py represents pyridin-2-yl, and -Q- represents pyridin-2,6-diyl.

(B) Ligands of the general formula (IB):

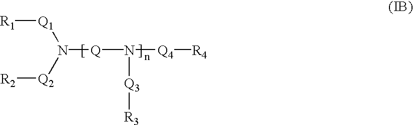

wherein

n=1 or 2, whereby if n=2, then each -Q₃-R₃ group is independently defined;

R₁, R₂, R₃, R₄ independently represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E,

Q₁, Q₂, Q₃, Q₄ and Q independently represent a group of the formula:

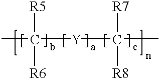

wherein

5≧a+b+c>1; a=0-5; b=0-5; c=0-5; n=1 or 2;

Y independently represents a group selected from —O—, —S—, —SO—, —SO₂—, —C(O)—, arylene, alkylene, heteroarylene, heterocycloalkylene, —(G)P—, —P(O)—and —(G)N—, wherein G is selected from hydrogen, alkyl, aryl, arylalkyl, cycloalkyl, each except hydrogen being optionally substituted by one or more functional groups E;

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I,

provided that at least two of R₁, R₂, R₃, R₄ comprise coordinating heteroatoms and no more than six heteroatoms are coordinated to the same transition metal atom.

At least two, and preferably at least three, of R₁, R₂, R₃, R₄ independently represent a group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. Preferably, substituents for groups R₁, R₂, R₃, R₄, when representing a heterocyclic or heteroaromatic ring, are selected from C₁₋₄-alkyl, aryl, arylalkyl, heteroaryl, methoxy, hydroxy, nitro, amino, carboxyl, halo, and carbonyl.

The groups Q₁, Q₂, Q₃, Q₄ preferably independently represent a group selected from —CH₂— and —CH₂CH₂—.

Group Q is preferably a group selected from —(CH₂)₂₋₄—, —CH₂CH(OH)CH₂—,

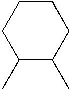

optionally substituted by methyl or ethyl,

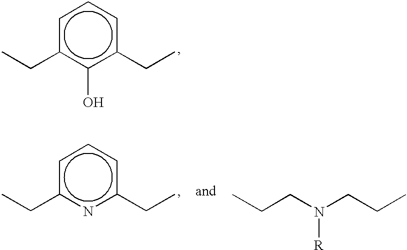

wherein R represents —H or C₁₋₄-alkyl.

Preferably, Q₁, Q₂, Q₃, Q₄ are defined such that a=b=0, c=1 and n=1, and Q is defined such that a=b=0, c=2 and n=1.

The groups R5, R6, R7, R8 preferably independently represent a group selected from —H, hydroxy-C₀-C₂₀-alkyl, halo-C₀-C₂₀-alkyl, nitroso, formyl-CO-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

In a preferred aspect, the ligand is of the general formula (IIB):

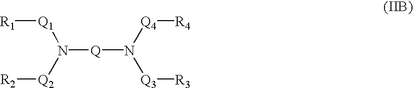

wherein

Q₁, Q₂, Q₃, Q₄ are defined such that a=b=0, c=1 or 2 and n=1;

Q is defined such that a=b=0, c=2,3 or 4 and n=1; and

R₁, R₂, R₃, R₄, R7, R8 are independently defined as for formula (I).

Preferred classes of ligands according to this aspect, as represented by formula (IIB) above, are as follows:

(i) ligands of the general formula (IIB) wherein:

R₁, R₂, R₃, R₄ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

In this class, we prefer that:

Q is defined such that a=b=0, c=2 or 3 and n=1;

R₁, R₂, R₃, R₄ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

(ii) ligands of the general formula (IIB) wherein:

R₁, R₂, R₃ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

R₄ represents a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

Q is defined such that a=b=0, c=2 or 3 and n=1;

R₁, R₂, R₃ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

R₄ represents a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

(iii) ligands of the general formula (IIB) wherein:

R₁, R₄ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

R₂, R₃ each independently represent a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

Q is defined such that a=b=0, c=2 or 3 and n=1;

R₁, R₄ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

R₂, R₃ each independently represent a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

Examples of preferred ligands in their simplest forms are:

N,N′,N′-tris(3-methyl-pyridin-2-ylmethyl)-ethylenediamine;

N-trimethylammoniumpropyl-N,N′,N′-tris(pyridin-2-ylmethyl)-ethylenediamine;

N-(2-hydroxyethylene)-N,N′,N′-tris(pyridin-2-ylmethyl)-ethylenediamine;

N,N,N′,N′-tetrakis(3-methyl-pyridin-2-ylmethyl)-ethylene-diamine;

N,N′-dimethyl-N,N′-bis(pyridin-2-ylmethyl)-cyclohexane-1,2-diamine;

N-(2-hydroxyethylene)-N,N′,N′-tris(3-methyl-pyridin-2-ylmethyl)-ethylenediamine;

N-methyl-N,N′,N′-tris(pyridin-2-ylmethyl)-ethylenediamine;

N-methyl-N,N′,N′-tris(5-ethyl-pyridin-2-ylmethyl)-ethylenediamine;

N-methyl-N,N′,N′-tris(5-methyl-pyridin-2-ylmethyl)-ethylenediamine;

N-methyl-N,N′,N′-tris(3-methyl-pyridin-2-ylmethyl)-ethylenediamine;

N-benzyl-N,N′,N′-tris(3-methyl-pyridin-2-ylmethyl)-ethylenediamine;

N-ethyl-N,N′,N′-tris(3-methyl-pyridin-2-ylmethyl)-ethylenediamine;

N,N,N′-tris(3-methyl-pyridin-2-ylmethyl)-N′(2′-methoxy-ethyl-1)-ethylenediamine;

N,N,N′-tris(1-methyl-benzimidazol-2-yl)-N′-methyl-ethylenediamine;

N-(furan-2-yl)-N,N′,N′-tris(3-methyl-pyridin-2-ylmethyl)-ethylenediamine;

N-(2-hydroxyethylene)-N,N′,N′-tris(3-ethyl-pyridin-2-ylmethyl)-ethylenediamine;

N-methyl-N,N′,N′-tris(3-methyl-pyridin-2-ylmethyl)ethylene-1,2-diamine;

N-ethyl-N,N′,N′-tris(3-methyl-pyridin-2-ylmethyl)ethylene-1,2-diamine;

N-benzyl-N,N′,N′-tris(3-methyl-pyridin-2-ylmethyl)ethylene-1,2-diamine;

N-(2-hydroxyethyl)-N,N′,N′-tris(3-methyl-pyridin-2-ylmethyl)ethylene-1,2-diamine;

N-(2-methoxyethyl)-N,N′,N′-tris(3-methyl-pyridin-2-ylmethyl)ethylene-1,2-diamine;

N-methyl-N,N′,N′-tris(5-methyl-pyridin-2-ylmethyl)ethylene-1,2-diamine;

N-ethyl-N,N′,N′-tris(5-methyl-pyridin-2-ylmethyl)ethylene-1,2-diamine;

N-benzyl-N,N′,N′-tris(5-methyl-pyridin-2-ylmethyl)ethylene-1,2-diamine;

N-(2-hydroxyethyl)-N,N′,N′-tris(5-methyl-pyridin-2-ylmethyl)ethylene-1,2-diamine;

N-(2-methoxyethyl)-N,N′,N′-tris(5-methyl-pyridin-2-ylmethyl)ethylene-1,2-diamine;

N-methyl-N,N′,N′-tris(3-ethyl-pyridin-2-ylmethyl)ethylene-1,2-diamine;

N-ethyl-N,N′,N′-tris(3-ethyl-pyridin-2-ylmethyl)ethylene-1,2-diamine;

N-benzyl-N,N′,N′-tris(3-ethyl-pyridin-2-ylmethyl)ethylene-1,2-diamine;

N-(2-hydroxyethyl)-N,N′,N′-tris(3-ethyl-pyridin-2-ylmethyl)ethylene-1,2-diamine;

N-(2-methoxyethyl)-N,N′,N′-tris(3-ethyl-pyridin-2-ylmethyl)ethylene-1,2-diamine;

N-methyl-N,N′,N′-tris(5-ethyl-pyridin-2-ylmethyl)ethylene-1,2-diamine;

N-ethyl-N,N′,N′-tris(5-ethyl-pyridin-2-ylmethyl)ethylene-1,2-diamine;

N-benzyl-N,N′,N′-tris(5-ethyl-pyridin-2-ylmethyl)ethylene-1,2-diamine; and

N-(2-methoxyethyl)-N,N′,N′-tris(5-ethyl-pyridin-2-ylmethyl)ethylene-1,2-diamine.

More preferred ligands are:

N-methyl-N,N′,N′-tris(3-methyl-pyridin-2-ylmethyl)ethylene-1,2-diamine;

N-ethyl-N,N′,N′-tris(3-methyl-pyridin-2-ylmethyl)ethylene-1,2-diamine;

N-benzyl-N,N′,N′-tris(3-methyl-pyridin-2-ylmethyl)ethylene-1,2-diamine;

N-(2-hydroxyethyl)-N,N′,N′-tris(3-methyl-pyridin-2-ylmethyl)ethylene-1,2-diamine; and

N-(2-methoxyethyl)-N,N′,N′-tris(3-methyl-pyridin-2-ylmethyl)ethylene-1,2-diamine.

(C) Ligands of the general formula (IC):

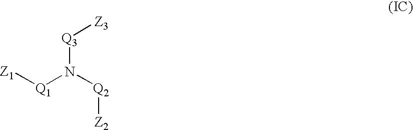

wherein

Z₁, Z₂ and Z₃ independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;

Q₁, Q₂, and Q₃ independently represent a group of the formula:

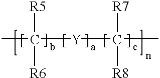

wherein

5≧a+b+c≧1; a=0-5; b=0-5; c=0-5; n=1 or 2;

Y independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E; and

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I.

Z₁, Z₂ and Z₃ each represent a coordinating group, preferably selected from optionally substituted pyridin-2-yl, optionally substituted imidazol-2-yl, optionally substituted imidazol-4-yl, optionally substituted pyrazol-1-yl, and optionally substituted quinolin-2-yl. Preferably, Z₁, Z₂ and Z₃ each represent optionally substituted pyridin-2-yl.

Optional substituents for the groups Z₁, Z₂ and Z₃ are preferably selected from C₁₋₄-alkyl, aryl, arylalkyl, heteroaryl, methoxy, hydroxy, nitro, amino, carboxyl, halo, and carbonyl, preferably methyl.

Also preferred is that Q₁, Q₂ and Q₃ are defined such that a=b=0, c=1 or 2, and n=1.

Preferably, each Q₁, Q₂ and Q₃ independently represent C,₄-alkylene, more preferably a group selected from —CH₂— and —CH₂CH₂—.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀alkyl, alkoxy-C₀-C₈-alkyl, carbonyl-C₀-C₆-alkoxy, and C₀-C₂₀-alkylamide. Preferably, none of R5-R8 is linked together.

Preferably, the ligand is selected from tris(pyridin-2-ylmethyl)amine, tris(3-methyl-pyridin-2-ylmethyl)amine, tris(5-methyl-pyridin-2-ylmethyl)amine, and tris(6-methyl-pyridin-2-ylmethyl)amine.

(D) Ligands of the general formula (ID):

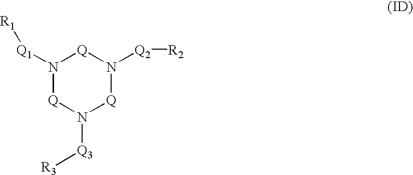

wherein

R₁, R₂, and R₃ independently represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E;

Q independently represent a group selected from C₂-₃-alkylene optionally substituted by H, benzyl or C₁₋₈-alkyl;

Q₁, Q₂ and Q₃ independently represent a group of the formula:

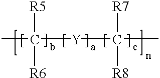

wherein

5≧a+b+c≧1; a=0-5; b=0-5; c=0-5; n=1 or 2;

Y independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E; and

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I,

provided that at least one, preferably at least two, of R₁, R₂ and R₃ is a coordinating group.

At least two, and preferably at least three, of R₁, R₂ and R₃ independently represent a group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. Preferably, at least two of R₁, R₂, R₃each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

Preferably, substituents for groups R₁, R₂, R₃, when representing a heterocyclic or heteroaromatic ring, are selected from C₁₋₄-alkyl, aryl, arylalkyl, heteroaryl, methoxy, hydroxy, nitro, amino, carboxyl, halo, and carbonyl.

Preferably, Q₁, Q₂ and Q₃ are defined such that a=b=0, c=1,2,3 or 4 and n=1. Preferably, the groups Q₁, Q₂ and Q₃ independently represent a group selected from —CH₂— and —CH₂CH₂—.

Group Q is preferably a group selected from —CH₂CH₂— and —CH₂CH₂CH₂—.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

In a preferred aspect, the ligand is of the general formula (IID):

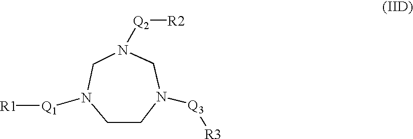

wherein R1, R2, R3 are as defined previously for R₁, R₂, R₃, and Q₁, Q₂, Q₃ are defined previously.

Preferred classes of ligands according to this preferred aspect, as represented by formula (IID) above, are as follows:

(i) ligands of the general formula (IID) wherein:

R1, R2, R3 each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

In this class, we prefer that:

R1, R2, R3each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

(ii) ligands of the general formula (IID) wherein:

two of R1, R2, R3 each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

one of R1, R2, R3 represents a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

two of R1, R2, R3 each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

one of R1, R2, R3 represents a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

In especially preferred embodiments, the ligand is selected from:

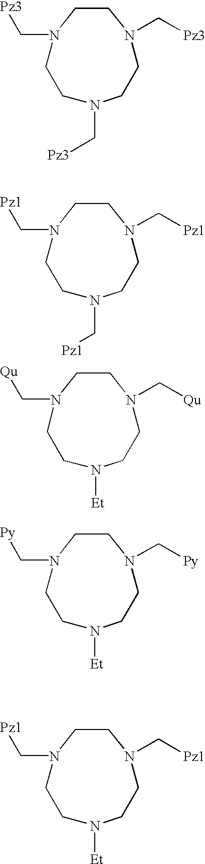

wherein -Et represents ethyl, -Py represents pyridin-2-yl, Pz3 represents pyrazol-3-yl, Pz1 represents pyrazol-1-yl, and Qu represents quinolin-2-yl.

(E) Ligands of the general formula (IE):

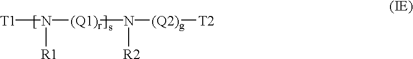

g represents zero or an integer from 1 to 6;

r represents an integer from 1 to 6;

s represents zero or an integer from 1 to 6;

Q1 and Q2 independently represent a group of the formula:

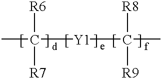

5≧d+e+f≧1; d=0-5; e=0-5; f=0-5;

each Y1 independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

if s>1, each —[—N(R1 )-(Q1 )ᵣ-]- group is independently defined;

R1, R2, R6, R7, R8, R9 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R6 together with R7, or R8 together with R9, or both, represent oxygen,

or R6 together with R8 and/or independently R7 together with R9, or R6 together with R9 and/or independently R7 together with R8, represent C₁₋₆-alkylene optionally substituted by C₁₋₄-alkyl, —F, —Cl, —Br or —I;

or one of R1-R9 is a bridging group bound to another moiety of the same general formula;

T1 and T2 independently represent groups R4 and R5, wherein R4 and R5 are as defined for R1-R9, and if g=0 and s>0, R1 together with R4, and/or R2 together with R5, may optionally independently represent ═CH—R10, wherein R10 is as defined for R1-R9, or

T1 and T2 may together (-T2-T1-) represent a covalent bond linkage when s>1 and g>0;

if T1 and T2 together represent a single bond linkage, Q1 and/or Q2 may independently represent a group of the formula: ═CH—[—Y1-]ₑ—CH═ provided R1 and/or R2 are absent, and R1 and/or R2 may be absent provided Q1 and/or Q2 independently represent a group of the formula: ═CH—[—Y1-]ₑCH═.

The groups R1-R9 are preferably independently selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulpho-C₀-C₂₀-alkyl and esters and salts thereof, sulphamoyl-C₀-C₂₀-alkyl, amino-C₀-C₂₀-alkyl, aryl-C₀-C₂₀-alkyl, heteroaryl-C₀-C₂₀-alkyl, C₀-C₂₀-alkyl, alkoxy-C₀-C₈-alkyl, carbonyl-C₀-C₆-alkoxy, and aryl-C₀-C₆-alkyl and C₀-C₂₀-alkylamide.

One of R1-R9 may be a bridging group which links the ligand moiety to a second ligand moiety of preferably the same general structure. In this case the bridging group is independently defined according to the formula for Q1, Q2, preferably being alkylene or hydroxy-alkylene or a heteroaryl-containing bridge, more preferably C₁₋₆-alkylene optionally substituted by C₁₋₄-alkyl, —F, —Cl, —Br or —I.

In a first variant according to formula (IE), the groups T1 and T2 together form a single bond linkage and s>1, according to general formula (IIE):

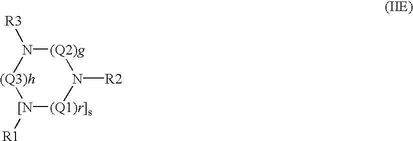

wherein R3 independently represents a group as defined for R1-R9; Q3 independently represents a group as defined for Q1, Q2; h represents zero or an integer from 1 to 6; and s=s-1.

In a first embodiment of the first variant, in general formula (IIE), s=1, 2 or 3; r=g=h=1; d=2 or 3; e=f=0; R6=R7=H, preferably such that the ligand has a general formula selected from:

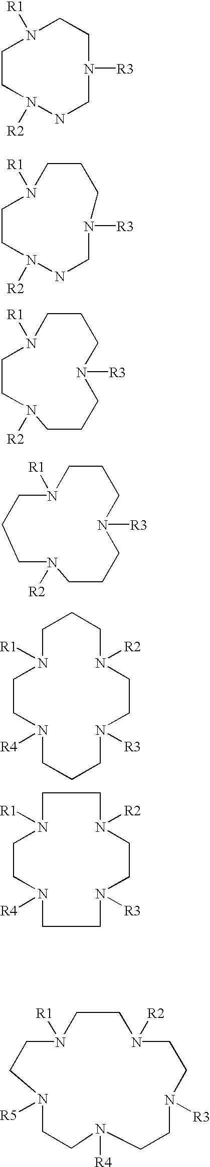

In these preferred examples, R1, R2, R3 and R4 are preferably independently selected from —H, alkyl, aryl, heteroaryl, and/or one of R1-R4 represents a bridging group bound to another moiety of the same general formula and/or two or more of R1-R4 together represent a bridging group linking N atoms in the same moiety, with the bridging group being alkylene or hydroxy-alkylene or a heteroaryl-containing bridge, preferably heteroarylene. More preferably, R1, R2, R3 and R4 are independently selected from —H, methyl, ethyl, isopropyl, nitrogen-containing heteroaryl, or a bridging group bound to another moiety of the same general formula or linking N atoms in the same moiety with the bridging group being alkylene or hydroxy-alkylene.

In a second embodiment of the first variant, in general formula (IIE), s=2 and r=g=h=1, according to the general formula:

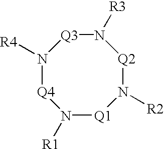

In this second embodiment, preferably R1-R4 are absent; both Q1 and Q3 represent ═CH—[—Y1-]ₑ—CH═; and both Q2 and Q4 represent —CH₂—[—Y1-]ₙ—CH₂—.

Thus, preferably the ligand has the general formula:

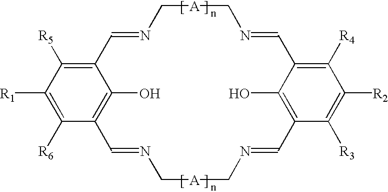

wherein A represents optionally substituted alkylene optionally interrupted by a heteroatom; and n is zero or an integer from 1 to 5.

Preferably, R1-R6 represent hydrogen, n=1 and A=—CH₂—, —CHOH—, —CH₂N(R)CH₂—or —CH₂CH₂N(R)CH₂CH₂— wherein R represents hydrogen or alkyl, more preferably A=—CH₂—, —CHOH— or —CH₂CH₂NHCH₂CH₂—.

In a second variant according to formula (IE), T1 and T2 independently represent groups R4, R5 as defined for R1-R9, according to the general formula (IIIE):

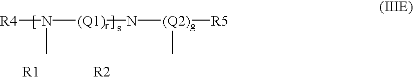

In a first embodiment of the second variant, in general formula (IIIE), s=1; r=1; g=0; d=f=1; e=0-4; Y1=—CH₂—; and R1 together with R4, and/or R2 together with R5, independently represent ═CH—R10, wherein R10 is as defined for R1-R9. In one example, R2 together with R5 represents ═CH—R10, with R1 and R4 being two separate groups. Alternatively, both R1 together with R4, and R2 together with R5 may independently represent ═CH—R10. Thus, preferred ligands may for example have a structure selected from:

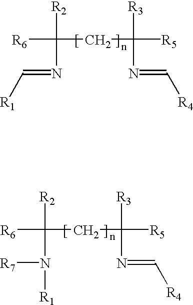

wherein n=0-4.

Preferably, the ligand is selected from:

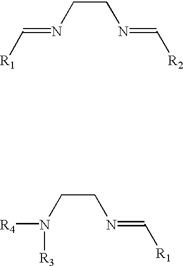

wherein R1 and R2 are selected from optionally substituted phenols, heteroaryl-C₀-C₂₀-alkyls, R3 and R4 are selected from —H, alkyl, aryl, optionally substituted phenols, heteroaryl-C₀-C₂₀-alkyls, alkylaryl, aminoalkyl, alkoxy, more preferably R1 and R2 being selected from optionally substituted phenols, heteroaryl-C₀-C₂-alkyls, R3 and R4 are selected from —H, alkyl, aryl, optionally substituted phenols, nitrogen-heteroaryl-C₀-C₂-alkyls.

In a second embodiment of the second variant, in general formula (IIIE), s=1; r=1; g=0; d=f=1; e=1-4; Y1=—C(R′)(R″), wherein R′ and R″ are independently as defined for R1-R9. Preferably, the ligand has the general formula:

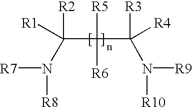

The groups R1, R2, R3, R4, R5 in this formula are preferably —H or C₀-C₂₀-alkyl, n=0 or 1, R6 is —H, alkyl, —OH or —SH, and R7, R8, R9, R10 are preferably each independently selected from —H, C₀-C₂₀-alkyl, heteroaryl-C₀-C₂₀-alkyl, alkoxy-C₀-C₈-alkyl and amino-C₀-C₂₀-alkyl.

In a third embodiment of the second variant, in general formula (IIIE), s=0; g=1; d=e=0; f=1-4. Preferably, the ligand has the general formula:

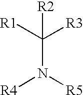

This class of ligand is particularly preferred according to the invention.

More preferably, the ligand has the general formula:

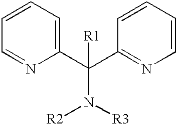

wherein R1, R2, R3 are as defined for R2, R4, R5.

In a fourth embodiment of the second variant, the ligand is a pentadentate ligand of the general formula (IVE):

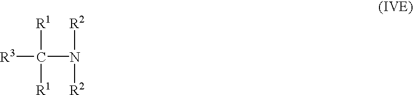

wherein

each R¹, R² independently represents —R⁴—R⁵,

R³ represents hydrogen, optionally substituted alkyl, aryl or arylalkyl, or —R⁴—R⁵,

each R⁴ independently represents a single bond or optionally substituted alkylene, alkenylene, oxyalkylene, aminoalkylene, alkylene ether, carboxylic ester or carboxylic amide, and

each R⁵ independently represents an optionally N-substituted aminoalkyl group or an optionally substituted heteroaryl group selected from pyridinyl, pyrazinyl, pyrazolyl, pyrrolyl, imidazolyl, benzimidazolyl, pyrimidinyl, triazolyl and thiazolyl.

Ligands of the class represented by general formula (IVE) are also particularly preferred according to the invention. The ligand having the general formula (IVE), as defined above, is a pentadentate ligand. By ‘pentadentate’ herein is meant that five hetero atoms can coordinate to the metal M ion in the metal-complex.

In formula (IVE), one coordinating hetero atom is provided by the nitrogen atom in the methylamine backbone, and preferably one coordinating hetero atom is contained in each of the four R¹ and R² side groups. Preferably, all the coordinating hetero atoms are nitrogen atoms.

The ligand of formula (IVE) preferably comprises at least two substituted or unsubstituted heteroaryl groups in the four side groups. The heteroaryl group is preferably a pyridin-2-yl group and, if substituted, preferably a methyl- or ethyl-substituted pyridin-2-yl group. More preferably, the heteroaryl group is an unsubstituted pyridin-2-yl group. Preferably, the heteroaryl group is linked to methylamine, and preferably to the N atom thereof, via a methylene group. Preferably, the ligand of formula (IVE) contains at least one optionally substituted amino-alkyl side group, more preferably two amino-ethyl side groups, in particular 2-(N-alkyl)amino-ethyl or 2-(N,N-dialkyl)amino-ethyl.

Thus, in formula (IVE) preferably R¹ represents pyridin-2-yl or R² represents pyridin-2-yl-methyl. Preferably R² or R¹ represents 2-amino-ethyl, 2-(N-(m)ethyl)amino-ethyl or 2-(N,N-di(m)ethyl)amino-ethyl. If substituted, R⁵ preferably represents 3-methyl pyridin-2-yl. R³ preferably represents hydrogen, benzyl or methyl.

Examples of preferred ligands of formula (IVE) in their simplest forms are:

(i) pyridin-2-yl containing ligands such as:

N,N-bis(pyridin-2-yl-methyl)-bis(pyridin-2-yl)methylamine;

N,N-bis(pyrazol-1-yl-methyl)-bis(pyridin-2-yl)methylamine;

N,N-bis(imidazol-2-yl-methyl)-bis(pyridin-2-yl)methylamine;

N,N-bis(1,2,4-triazol-1-yl-methyl)-bis(pyridin-2-yl)methylamine;

N,N-bis(pyridin-2-yl-methyl)-bis(pyrazol-1-yl)methylamine;

N,N-bis(pyridin-2-yl-methyl)-bis(imidazol-2-yl)methylamine;

N,N-bis(pyridin-2-yl-methyl)-bis(1,2,4-triazol-1-yl)methylamine;

N,N-bis(pyridin-2-yl-methyl)-1,1-bis(pyridin-2-yl)-1-aminoethane;

N,N-bis(pyridin-2-yl-methyl)-1,1-bis(pyridin-2-yl)-2-phenyl-1-aminoethane;

N,N-bis(pyrazol-1-yl-methyl)-1,1-bis(pyridin-2-yl)-1-aminoethane;

N,N-bis(pyrazol-1-yl-methyl)-1,1-bis(pyridin-2-yl)-2-phenyl-1-aminoethane;

N,N-bis(imidazol-2-yl-methyl)-1,1-bis(pyridin-2-yl)-1-aminoethane;

N,N-bis(imidazol-2-yl-methyl)-1,1-bis(pyridin-2-yl)-2-phenyl-1-aminoethane;

N,N-bis(1,2,4-triazol-1-yl-methyl)-1,1-bis(pyridin-2-yl)-1-aminoethane;

N,N-bis(1,2,4-triazol-1-yl-methyl)-1,1-bis(pyridin-2-yl)-2-phenyl-1-aminoethane;

N,N-bis(pyridin-2-yl-methyl)-1,1-bis(pyrazol-1-yl)-1-aminoethane;

N,N-bis(pyridin-2-yl-methyl)-1,1-bis(pyrazol-1-yl)-2-phenyl-1-aminoethane;

N,N-bis(pyridin-2-yl-methyl)-1,1-bis(imidazol-2-yl)-1-aminoethane;

N,N-bis(pyridin-2-yl-methyl)-1,1-bis(imidazol-2-yl)-2-phenyl-1-aminoethane;

N,N-bis(pyridin-2-yl-methyl)-1,1-bis(1,2,4-triazol-1-yl)-1-aminoethane;

N,N-bis(pyridin-2-yl-methyl)-1,1-bis(1,2,4-triazol-1-yl)-1-aminoethane;

N,N-bis(pyridin-2-yl-methyl)-1,1-bis(pyridin-2-yl)-1-aminoethane;

N,N-bis(pyridin-2-yl-methyl)-1,1-bis(pyridin-2-yl)-1-aminohexane;

N,N-bis(pyridin-2-yl-methyl)-1,1-bis(pyridin-2-yl)-2-phenyl-1-aminoethane;

N,N-bis(pyridin-2-yl-methyl)-1,1-bis(pyridin-2-yl)-2-(4-sulphonic acid-phenyl)-1-aminoethane;

N,N-bis(pyridin-2-yl-methyl)-1,1-bis(pyridin-2-yl)-2-(pyridin-2-yl)-1-aminoethane;

N,N-bis(pyridin-2-yl-methyl)-1,1-bis(pyridin-2-yl)-2-(pyridin-3-yl)-1-aminoethane;

N,N-bis(pyridin-2-yl-methyl)-1,1-bis(pyridin-2-yl)-2-(pyridin-4-yl)-1-aminoethane;

N,N-bis(pyridin-2-yl-methyl)-1,1-bis(pyridin-2-yl)-2-(1-alkyl-pyridinium-4-yl)-1-aminoethane;

N,N-bis(pyridin-2-yl-methyl)-1,1-bis(pyridin-2-yl)-2-(1-alkyl-pyridinium-3-yl)-1-aminoethane;

N,N-bis(pyridin-2-yl-methyl)-1,1-bis(pyridin-2-yl)-2-(1-alkyl-pyridinium-2-yl)-1-aminoethane;

(ii) 2-amino-ethyl containing ligands such as:

N,N-bis(2-(N-alkyl)amino-ethyl)-bis(pyridin-2-yl)methylamine;

N,N-bis(2-(N-alkyl)amino-ethyl)-bis(pyrazol-1-yl)methylamine;

N,N-bis(2-(N-alkyl)amino-ethyl)-bis(imidazol-2-yl)methylamine;

N,N-bis(2-(N-alkyl)amino-ethyl)-bis(1,2,4-triazol-1-yl)methylamine;

N,N-bis(2-(N,N-dialkyl)amino-ethyl)-bis(pyridin-2-yl)methylamine;

N,N-bis(2-(N,N-dialkyl)amino-ethyl)-bis(pyrazol-1-yl)methylamine;

N,N-bis(2-(N,N-dialkyl)amino-ethyl)-bis(imidazol-2-yl)methylamine;

N,N-bis(2-(N,N-dialkyl)amino-ethyl)-bis(1,2,4-triazol-1-yl)methylamine;

N,N-bis(pyridin-2-yl-methyl)-bis(2-amino-ethyl)methylamine;

N,N-bis(pyrazol-1-yl-methyl)-bis(2-amino-ethyl)methylamine;

N,N-bis(imidazol-2-yl-methyl)-bis(2-amino-ethyl)methylamine;

N,N-bis(1,2,4-triazol-1-yl-methyl)-bis(2-amino-ethyl)methylamine.

More preferred ligands are:

N,N-bis(pyridin-2-yl-methyl)-bis(pyridin-2-yl)methylamine, hereafter referred to as N4Py.

N,N-bis(pyridin-2-yl-methyl)-1,1-bis(pyridin-2-yl)-1-aminoethane, hereafter referred to as MeN4Py,

N,N-bis(pyridin-2-yl-methyl)-1,1-bis(pyridin-2-yl)-2-phenyl-1-aminoethane, hereafter referred to as BzN4Py.

In a fifth embodiment of the second variant, the ligand represents a pentadentate or hexadentate ligand of general formula (VE):

R¹R¹N—W—NR¹R²

### (VE)

wherein

each R¹ independently represents —R³-V, in which R³ represents optionally substituted alkylene, alkenylene, oxyalkylene, aminoalkylene or alkylene ether, and V represents an optionally substituted heteroaryl group selected from pyridinyl, pyrazinyl, pyrazolyl, pyrrolyl, imidazolyl, benzimidazolyl, pyrimidinyl, triazolyl and thiazolyl;

W represents an optionally substituted alkylene bridging group selected from —CH₂CH₂—, —CH₂CH₂CH₂—, —CH₂CH₂CH₂CH₂—, —CH₂—C₆H₄—CH₂—, —CH₂—C₆H₁₀—CH₂—, and —CH₂—C₁₀H₆—CH₂—; and

R² represents a group selected from R¹, and alkyl, aryl and arylalkyl groups optionally substituted with a substituent selected from hydroxy, alkoxy, phenoxy, carboxylate, carboxamide, carboxylic ester, sulphonate, amine, alkylamine and N⁺(R⁴)₃, wherein R⁴ is selected from hydrogen, alkanyl, alkenyl, arylalkanyl, arylalkenyl, oxyalkanyl, oxyalkenyl, aminoalkanyl, aminoalkenyl, alkanyl ether and alkenyl ether.

The ligand having the general formula (VE), as defined above, is a pentadentate ligand or, if R¹=R², can be a hexadentate ligand. As mentioned above, by ‘pentadentate’ is meant that five hetero atoms can coordinate to the metal M ion in the metal-complex. Similarly, by ‘hexadentate’ is meant that six hetero atoms can in principle coordinate to the metal M ion. However, in this case it is believed that one of the arms will not be bound in the complex, so that the hexadentate ligand will be penta coordinating.

In the formula (VE), two hetero atoms are linked by the bridging group W and one coordinating hetero atom is contained in each of the three R¹ groups. Preferably, the coordinating hetero atoms are nitrogen atoms.

The ligand of formula (VE) comprises at least one optionally substituted heteroaryl group in each of the three R¹ groups. Preferably, the heteroaryl group is a pyridin-2-yl group, in particular a methyl- or ethyl-substituted pyridin-2-yl group. The heteroaryl group is linked to an N atom in formula (VE), preferably via an alkylene group, more preferably a methylene group. Most preferably, the heteroaryl group is a 3-methyl-pyridin-2-yl group linked to an N atom via methylene.

The group R² in formula (VE) is a substituted or unsubstituted alkyl, aryl or arylalkyl group, or a group R¹. However, preferably R² is different from each of the groups R¹ in the formula above. Preferably, R² is methyl, ethyl, benzyl, 2-hydroxyethyl or 2-methoxyethyl. More preferably, R² is methyl or ethyl.

The bridging group W may be a substituted or unsubstituted alkylene group selected from —CH₂CH₂—, —CH₂CH₂CH₂—, —CH₂CH₂CH₂CH₂—, —CH₂—C₆H₄—CH₂—, —CH₂—C₆H₁₀—CH₂—, and —CH₂—C₁₀H₆—CH₂— (wherein —C₆H₄—, —C₆H₁₀—, —C₁₀ H₆— can be ortho-, para-, or meta-C₆H₄—, —C₆H₁₀—, —C₁₀ H₆—). Preferably, the bridging group W is an ethylene or 1,4-butylene group, more preferably an ethylene group.

Preferably, V represents substituted pyridin-2-yl, especially methyl-substituted or ethyl-substituted pyridin-2-yl, and most preferably V represents 3-methyl pyridin-2-yl.

(F) Ligands of the classes disclosed in WO-A-98/39098 and WO-A-98/39406.

(H) Ligand having the formula (HI):

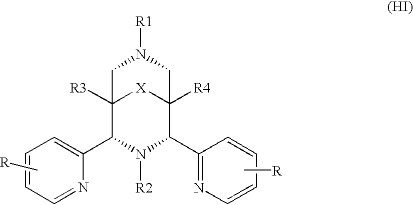

wherein each R is independently selected from: hydrogen, hydroxyl, —NH—CO—H, —NH—CO—C1-C4-alkyl, —NH2, —NH—C1-C4-alkyl, and C1-C4-alkyl;

R1 and R2 are independently selected from:

C1-C4-alkyl,

C6-C10-aryl, and,

a group containing a heteroatom capable of coordinating to a transition metal, preferably wherein at least one of R1 and R2 is the group containing the heteroatom;

R3 and R4 are independently selected from hydrogen, C1-C8 alkyl, C1-C8-alkyl-O-C1-C8-alkyl, C1-C8-alkyl-O-C6-C10-aryl, C6-C10-aryl, C1-C8-hydroxyalkyl, and —(CH2)ₙC(O)OR5

wherein R5 is C1-C4-alkyl, n is from 0 to 4, and mixtures thereof; and,

X is selected from C═O, —[C(R6)₂]_{y}— wherein Y is from 0 to 3 each R6 is independently selected from hydrogen, hydroxyl, C1-C4-alkoxy and C1-C4-alkyl.

(I) A further class of ligands is the macropolycyclic rigid ligand of formula (I) having denticity of 3 or 4:

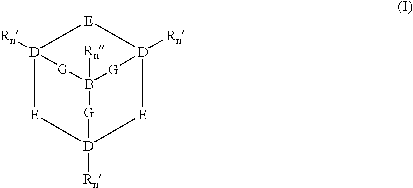

(ii) the macropolycyclic rigid ligand of formula (II) having denticity of 4 or 5

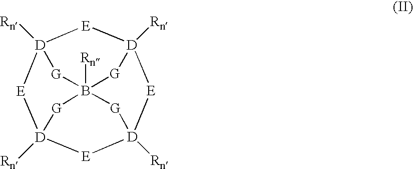

(iii) the macropolycyclic rigid ligand of formula (III) having denticity of 5 or 6:

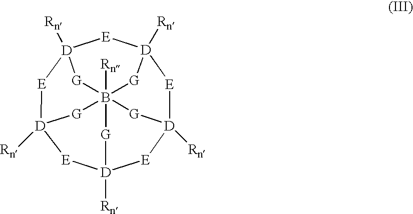

(iv) the macropolycyclic rigid ligand of formula (IV) having denticity of 6 or 7

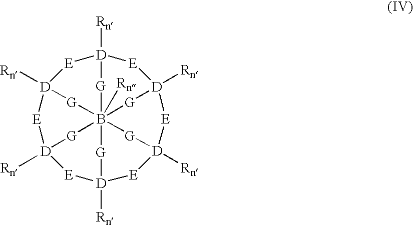

wherein in these formulas:—each “E” is the moiety (CRₙ)ₐ-X-(CRₙ)_{a′}, wherein X is selected from the group consisting of O, S, NR and P, or a covalent bond, and preferably X is a covalent bond and for each E the sum of a+a′ is independently selected from 1 to 5, more preferably 2 and 3.

each “G” is the moiety (CRₙ)ₙ.

each “R” is independently selected from H, alkyl, alkenyl, alkynyl, aryl, alkylaryl (e.g., benzyl), and heteroaryl, or two or more R are covalently bonded to form an aromatic, heteroaromatic, cycloalkyl, or heterocycloalkyl ring.

each “D” is a donor atom independently selected from the group consisting of N, O, S, and P, and at least two D atoms are bridgehead donor atoms coordinated to the transition metal (in the preferred embodiments, all donor atoms designated D are donor atoms which coordinate to the transition metal, in contrast with heteroatoms in the structure which are not in D such as those which may be present in E; the non-D heteroatoms can be non-coordinating and indeed are non-coordinating whenever present in the preferred embodiment).

“B” is a carbon atom or “D” donor atom, or a cycloalkyl or heterocyclic ring.

each “n” is an integer independently selected from 1 and 2, completing the valence of the carbon atoms to which the R moieties are covalently bonded.

each “n′” is an integer independently selected from 0 and 1, completing the valence of the D donor atoms to which the R moieties are covalently bonded.

each “n″” is an integer independently selected from 0.1, and 2 completing the valence of the B atoms to which the R moieties are covalently bonded.

each “a” and “a′” is an integer independently selected from 0-5, preferably a+a′ equals 2 or 3, wherein the sum of all “a” plus “a′” in the ligand of formula (I) is within the range of from about 7 to about 11. The sum of all “a” plus “a” in the ligand of formula (II) is within the range of from about 6 (preferably 8) to about 12. The sum of all “a” plus “a′” in the ligand of formula (III) is within the range of from about 8 (preferably 10) to about 15, and the sum of all “a” plus “a′” in the ligand of formula (IV) is within the range of from about 10 (preferably 12) to about 18.

each “b” is an integer independently selected from 0-9, preferably 0-5 (wherein when b=0, (CRₙ)₀ represents a covalent bond), or in any of the above formulas, one or more of the (CRₙ)_{b} moieties covalently bonded from any D to the B atom is absent as long as at least two (CRₙ)_{b} covalently bond two of the D donor atoms to the B atom in the formula, and the sum of all “b” is within the range of from about 1 to about 5.

A preferred sub-group of the transition-metal complexes includes the Mn(II), Fe(II) and Cu(II) complexes of the ligand 1.2:

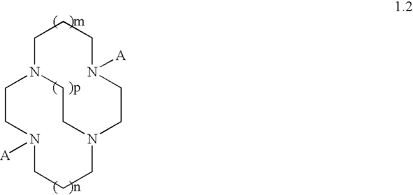

wherein m and n are integers from 0 to 2, p is an integer from 1 to 6, preferably m and n are both 0 or both 1 (preferably both 1), or m is 0 and n is at least 1; and p is 1; and A is a nonhydrogen moiety preferably having no aromatic content; more particularly each A can vary independently and is preferably selected from methyl, ethyl, propyl, isopropyl, butyl, isobutyl, tert-butyl, C5-C20 alkyl, and one, but not both, of the A moieties is benzyl, and combinations thereof. In one such complex, one A is methyl and one A is benzyl.

Dichloro-5,12-dimethyl-1,5,8,12-tetraazabicyclo[6.6.2]hexadecane Manganese(II)

Dichloro-4,10-dimethyl-1,4,7,10-tetraazabicyclo[5.5.2]tetradecane Manganese(II)

Diaquo-5,12-dimethyl-1,5,8,12-tetraazabicyclo[6.6.2]hexadecane Manganese(II) Hexafluorophosphate

Aquo-hydroxy-5,12-dimethyl-1,5,8,12-tetraazabicyclo[6.6.2]hexadecane Manganese(III) Hexafluorophosphate

Diaquo-4,10-dimethyl-1,4,7,10-tetraazabicyclo[5.5.2]tetradecane Manganese(II) Hexafluorophosphate

Diaquo-5,12-dimethyl-1,5,8,12-tetraazabicyclo6.6.2hexadecane Manganese(II) Tetrafluoroborate

Diaquo-4,10-dimethyl-1,4,7,10-tetraazabicyclo [5.5.2]tetradecane Manganese(II) Tetrafluoroborate

Dichloro-5,12-dimethyl-1,5,8,12-tetraazabicyclo[6.6.2]hexadecane Manganese(III) Hexafluorophosphate

Dichloro-5,12-di-n-butyl-1,5,8,12-tetraazabicyclo[6.6.2]hexadecane Manganese(II)

Dichloro-5,12-dibenzyl-1,5,8,12-tetraazabicyclo[6.6.2]hexadecane Manganese(II)

Ddichloro-5-n-butyl-12-methyl-1,5,8,12-tetraazabicyclo[6.6.2]hexadecane Manganese(II)

Dichloro-5-n-octyl-12-methyl-1,5,8,12-tetraaza-bicyclo[6.6.2]hexadecane Manganese(II)

Dichloro-5-n-butyl-12-methyl-1,5,8,12-tetraaza-bicyclo[6.6.2]hexadecane Manganese(II)

Dichloro-5,12-dimethyl-1,5,8,12-tetraazabicyclo[6.6.2]hexadecane Iron(II)

Dichloro-4,10-dimethyl-1,4,7,10-tetraazabicyclo[5.5.2]tetradecane Iron(II)

Dichloro-5,12-dimethyl-1,5,8,12-tetraazabicyclo[6.6.2]hexadecane Copper(II)

Dichloro-4,10-dimethyl-1,4,7,10-tetraazabicyclo[5.5.2]tetradecane Copper(II)

Dichloro-5,12-dimethyl-1,5,8,12-tetraazabicyclo[6.6.2]hexadecane Cobalt(II)

Dichloro-4,10-dimethyl-1,4,7,10-tetraazabicyclo[5.5.2]tetradecane Cobalt(II)

Dichloro 5,12-dimethyl-4-phenyl-1,5,8,12-tetraazabicyclo[6.6.2]hexadecane Manganese(II)

Dichloro-4,10-dimethyl-3-phenyl-1,4,7,10-tetraazabicyclo[5.5.2]tetradecane Manganese(II)

Dichloro-5,12-dimethyl-4,9-diphenyl-1,5,8,12-tetraazabicyclo[6.6.2]hexadecane Manganese(II)

Dichloro-4,10-dimethyl-3,8-diphenyl-1,4,7,10-tetraazabicyclo[5.5.2]tetradecane Manganese(II)

Dichloro-5,12-dimethyl-2,11-diphenyl-1,5,8,12-tetraazabicyclo[6.6.2]hexadecane Manganese(II)

Dichloro-4,10-dimethyl-4,9-diphenyl-1,4,7,10-tetraazabicyclo[5.5.2]tetradecane Manganese(II)

Dichloro-2,4,5,9,11,12-hexamethyl-1,5,8,12-tetraazabicyclo[6.6.2]hexadecane Manganese(II)

Dichloro-2,3,5,9,10,12-hexamethyl-1,5,8,12-tetraazabicyclo[6.6.2]hexadecane Manganese(II)

Dichloro-2,2,4,5,9,9,11,12-octamethyl-1,5,8,12-tetraazabicyclo[6.6.2]hexadecane Manganese(II)

Dichloro-2,2,4,5,9,11,11,12-octamethyl-1,5,8,12-tetraazabicyclo[6.6.2]hexadecane Manganese(II)

Dichloro-3,3,5,10,10,12-hexamethyl-1,5,8,12-tetraazabicyclo[6.6.2]hexadecane Manganese(II)

Dichloro-3,5,10,12-tetramethyl-1,5,8,12-tetraazabicyclo[6.6.2]hexadecane Manganese(II)

Dichloro-3-butyl-5,10,12-trimethyl-1,5,8,12-tetraazabicyclo[6.6.2]hexadecane Manganese(II)

Dichloro-1,5,8,12-tetraazabicyclo[6.6.2]hexadecane Manganese(II)

Dichloro-1,4,7,10-tetraazabicyclo[5.5.2]tetradecane Manganese(II)

Dichloro-1,5,8,12-tetraazabicyclo[6.6.2]hexadecane Iron(II)

Dichloro-1,4,7,10-tetraazabicyclo[5.5.2]tetradecane Iron(II)

Aquo-chloro-2-(2-hydroxyphenyl)-5,12-dimethyl,5,8,12-tetraazabicyclo[6.6.2]hexadecane Manganese(II)

Aquo-chloro-10-(2-hydroxybenzyl)-4,10-dimethyl-1,4,7,10-tetraazabicyclo[5.5.2)tetradecane Manganese(II)

Chloro-2-(2-hydroxybenzyl)-5-methy 1,5,8,12-tetraazabicyclo[6.6.2]hexadecane Manganese(II)

Chloro-10-(2-hydroxybenzyl)-4-methyl-1,4,7,10-tetraazabicyclo[5.5.2]tetradecane Manganese(II)

Chloro-5-methyl-12-(2-picolyl)-1,5,8,12-tetraazabicyclo[6.6.2]hexadecane Manganese(II) Chloride

Chloro-4-methyl-10-(2-picolyl)-1,4,7,10-tetraazabicyclo[5.5.2]tetradecane Manganese(II) Chloride

Dichloro-5-(2-sulphato)dodecyl-12-methyl-1,5,8,12-tetraazabicyclo[6.6.2]hexadecane Manganese(III)

Aquo-Chloro-5-(2-sulphato)dodecyl-12-methyl-1,5,8,12-tetraazabicyclo[6.6.2]hexadecane Manganese(II)

Aquo-Chloro-5-(3-sulphonopropyl)-12-methyl-1,5,8,12-tetraazabicyclo[6.6.2]hexadecane Manganese(II)

Dichloro-5-(Trimethylammoniopropyl)dodecyl-12-methyl-1,5,8,12-tetraazabicyclo[6.6.2]hexadecane Manganese(III) Chloride

Dichloro-5,12-dimethyl-1,4,7,10,13-pentaazabicyclo[8.5.2]heptadecane Manganese(II)

Dichloro-14,20-dimethyl-1,10,14,20-tetraazatriyclo[8.6.6]docosa-3(8),4,6-triene Manganese(II)

Dichloro-4.11-dimethyl-1,4,7,11-tetraazabicyclo[6.5.2]pentadecane Manganese(II)

Dichloro-5,12-dimethyl-1,5,8,12-tetraazabicyclo[7.6.2]heptadecane Manganese(II)

Dichloro-5.13-dimethyl-1,5,9,13-tetraazabicyclo[7.7.2]heptadecane Manganese(II)

Dichloro-3,10-bis(butylcarboxy)-5,12-dimethyl-1,5,8,12-tetraazabicyclo[6.6.2]hexadecane Manganese(II)

Diaquo-3,10-dicarboxy-5,12-dimethyl-1,5,8,12-tetraazabicyclo[6.6.2]hexadecane Manganese(II)

Chloro-20-methyl-1,9,20,24,25-pentaaza-tetracyclo[7.7.7.1^{3,7}. 1^{11,15}]pentacosa-3,5,7(24),11,1315(25)-hexaene manganese(II) Hexafluorophosphate Trifluoromethanesulphono-20-methyl-1,9,20,24,25-pentaaza- tetracyclo[7.7.7.1^{3,7}.1^{11,15}]pentacosa-3,5,7(24), 11,13,1 5(25)-hexaene Manganese(II) trifluoromethanesulphonate

Trifluoromethanesulphono-20-methyl-1,9,20,24,25-pentaaza-tetracyclo[7.7.7.1^{3,7}.1^{11,15}.]pentacosa-3,5,7(24), 11,13,15(25)-hexaene Iron(II) trifluoromethanesulphonate

Chloro-5,12,17-trimethyl-1,5,8,12,17-pentaazabicyclo[6.6.5]nonadecane Manganese(II) hexafluorophosphate

Chloro-4,10,15-trimethyl-1,4,7,10,15-pentaazabicyclo[5.5.5]heptadecane Manganese(II) hexafluorophosphate

Chloro-5,12,17-trimethyl-1,5,8,12,17-pentaazabicyclo[6.6.5]nonadecane Manganese(II) chloride

Chloro-4,10,15-trimethyl-1,4,7,10,15-pentaazabicyclo[5.5.5]heptadecane Manganese(II) chloride

The invention further includes the compositions which include the transition-metal complexes, preferably the Mn, Fe, Cu and Co complexes, or preferred cross-bridged macropolycyclic ligands having the formula:

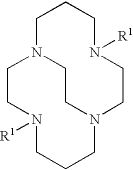

wherein in this formula “RI” is independently selected from H, and linear or branched, substituted or unsubstituted C1-C20 alkyl, alkylaryl, alkenyl or alkynyl, more preferably RI is alkyl or alkylaryl; and preferably all nitrogen atoms in the macropolycyclic rings are coordinated with the transition metal.

Also preferred are cross-bridged macropolycyclic ligands having the formula:

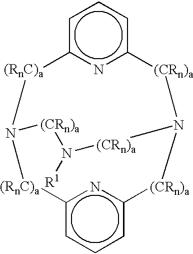

wherein in this formula:

each “n” is an integer independently selected from 1 and 2, completing the valence of the carbon atom to which the R moieties are covalently bonded;

each “R” and “R1” is independently selected from H, alkyl, alkenyl, alkynyl, aryl, alkylaryl (e.g., benzyl), and heteroaryl, or R and/or R1 are covalently bonded to form an aromatic, heteroaromatic, cycloalkyl, or heterocycloalkyl ring, and wherein preferably all R are H and R1 are independently selected from linear or branched, substituted or unsubstituted C1-C20 alkyl, alkenyl or alkynyl;

each “a” is an integer independently selected from 2 or 3;

preferably all nitrogen atoms in the macropolycyclic rings are coordinated with the transition metal. In terms of the present invention, even though any of such ligands are known, the invention encompasses the use of these ligands in the form of their transition-metal complexes as oxidation catalysts, or in the form of the defined catalytic systems.

In like manner, included in the definition of the preferred cross-bridged macropolycyclic ligands are those having the formula:

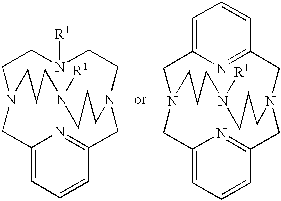

wherein in either of these formulae, “R^{I}” is independently selected from H, or, preferably, linear or branched, substituted or unsubstituted C1-C20 alkyl, alkenyl or alkynyl; and preferably all nitrogen atoms in the macropolycyclic rings are coordinated with the transition metal.

The present invention has numerous variations and alternate embodiments. Thus, in the foregoing catalytic systems, the macropolycyclic ligand can be replaced by any of the following:

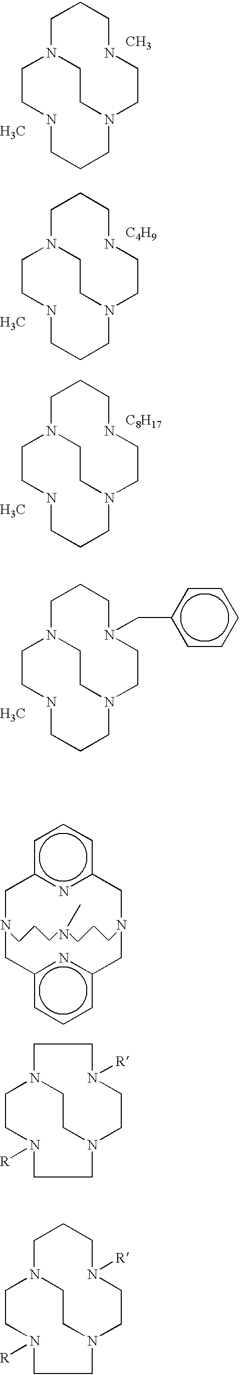

In the above, the R, R′, R″, R′″ moieties can, for example, be methyl, ethyl or propyl. (Note that in the above formalism, the short straight strokes attached to certain N atoms are an alternate representation for a methyl group).

While the above illustrative structures involve tetra-aza derivatives (four donor nitrogen atoms), ligands and the corresponding complexes in accordance with the present invention can also be made, for example from any of the following:

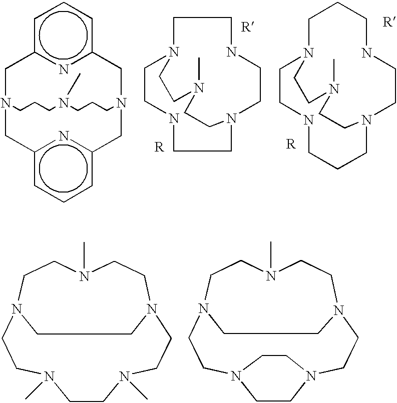

Moreover, using only a single organic macropolycycle, preferably a cross-bridged derivative of cyclam, a wide range of oxidation catalyst compounds of the invention may be prepared; numerous of these are believed to be novel chemical compounds. Preferred transition-metal catalysts of both cyclam-derived and non- cyclam-derived cross-bridged kinds are illustrated, but not limited, by the following:

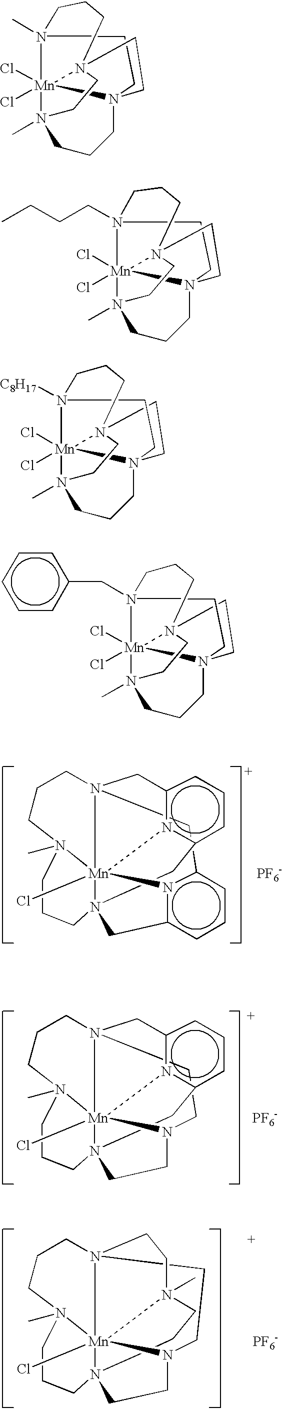

In other embodiments of the invention, transition-metal complexes, such as the Mn, Fe, Co, or Cu complexes, especially (II) and/or (III) oxidation state complexes, of the hereinabove-identified metals with any of the following ligands are also included:

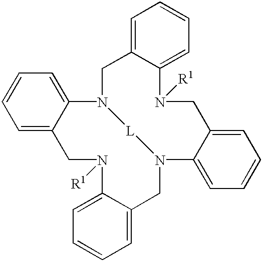

wherein RI is independently selected from H (preferably non-H) and linear or branched, substituted or unsubstituted C1-C20 alkyl, alkenyl or alkynyl and L is any of the linking moieties given herein, for example 1.10 or 1.11;

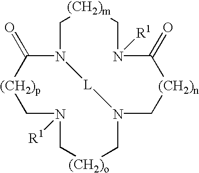

wherein RI is as defined supra; m,n,o and p can vary independently and are integers which can be zero or a positive integer and can vary independently while respecting the provision that the sum m+n+o+p is from 0 to 8 and L is any of the linking moieties defined herein;

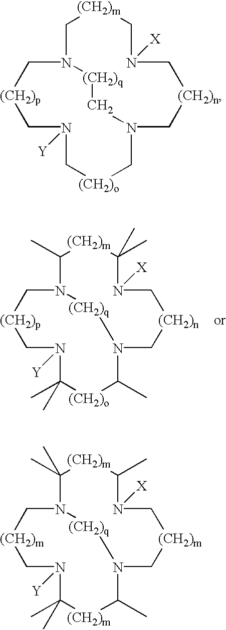

wherein X and Y can be any of the R1 defined supra, m,n,o and p are as defined supra and q is an integer, preferably from 1 to 4; or, more generally,

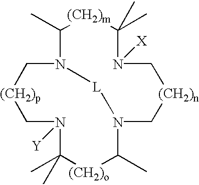

wherein L is any of the linking moieties herein, X and Y can be any of the RI defined supra, and m,n,o and p are as defined supra. Alternately, another useful ligand is:

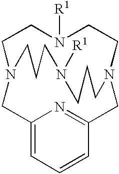

wherein RI is any of the RI moieties defined supra.

Pendant Moieties

Macropolycyclic rigid ligands and the corresponding transition-metal complexes and oxidation catalytic systems herein may also incorporate one or more pendant moieties, in addition to, or as a replacement for, R 1 moieties. Such pendant moieties are nonlimitingly illustrated by any of the following:

—(CH₂)ₙ—CH₃

—(CH₂)ₙ—CN

—(CH₂)ₙ—C(O)NR₂

—(CH₂)ₙ—C(O)OR

—(CH₂)ₙ—C(O)NH₂

—(CH₂)ₙ—C(O)OH

—(CH₂)ₙ—OH

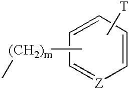

The counter ions Y in formula (A1) balance the charge z on the complex formed by the ligand L, metal M and coordinating species X. Thus, if the charge z is positive, Y may be an anion such as RCOO⁻, BPh₄⁻, ClO₄⁻, BF₄⁻, PF₆⁻, RSO₃⁻, RSO₄⁻, SO₄²⁻, NO₃⁻, F⁻, Cl⁻, Br⁻, or I⁻, with R being hydrogen, optionally substituted alkyl or optionally substituted aryl. If z is negative, Y may be a common cation such as an alkali metal, alkaline earth metal or (alkyl)ammonium cation.

Suitable counter ions Y include those which give rise to the formation of storage-stable solids. Preferred counter ions for the preferred metal complexes are selected from R⁷COO⁻, ClO₄⁻, BF₄⁻, PF₆⁻, RSO₃⁻ (in particular CF₃SO₃⁻), RSO₄⁻, SO₄²⁻, NO₃⁻, F⁻, Cl⁻, Br⁻, and I⁻, wherein R represents hydrogen or optionally substituted phenyl, naphthyl or C₁-C₄ alkyl.

Throughout the description and claims generic groups have been used, for example alkyl, alkoxy, aryl. Unless otherwise specified the following are preferred group restrictions that may be applied to generic groups found within compounds disclosed herein:

| | |
|---|---|
| alkyl: | C1-C6-alkyl, |
| alkenyl: | C2-C6-alkenyl, |
| cycloalkyl: | C3-C8-cycloalkyl, |
| alkoxy: | C1-C6-alkoxy, |
| alkylene: | selected from the group consisting of: methylene; 1,1-ethylene; 1,2-ethylene; |
| | 1,1-propylene; 1,2-propylene; 1,3-propylene; 2,2-propylene; butan-2-ol- |
| | 1,4-diyl; propan-2-ol-1,3-diyl; and 1,4-butylene, |
| aryl: | selected from homoaromatic compounds having a molecular weight under 300, |
| arylene: | selected from the group consisting of: 1,2-benzene; 1,3-benzene; 1,4- |
| | benzene; 1,2-naphthalene; 1,3-naphthalene; 1,4-naphthalene; 2,3- |
| | naphthalene; phenol-2,3-diyl; phenol-2,4-diyl; phenol-2,5-diyl; and |
| | phenol-2,-6-diyl, |
| heteroaryl: | selected from the group consisting of: pyridinyl; pyrimidinyl; pyrazinyl; triazolyl, |
| | pyridazinyl; 1,3,5-triazinyl; quinolinyl; isoquinolinyl; quinoxalinyl; |
| | imidazolyl; pyrazolyl; benzimidazolyl; thiazolyl; oxazolidinyl; pyrrolyl; |
| | carbazolyl; indolyl; and isoindolyl, |
| heteroarylene: | selected from the group consisting of: pyridin-2,3-diyl; pyridin-2,4-diyl; pyridin- |
| | 2,5-diyl; pyridin-2,6-diyl; pyridin-3,4-diyl; pyridin-3,5-diyl; quinolin-2,3- |
| | diyl; quinolin-2,4-diyl; quinolin-2,8-diyl; isoquinolin-1,3-diyl; isoquinolin- |
| | 1,4-diyl; pyrazol-1,3-diyl; pyrazol-3,5-diyl; triazole-3,5-diyl; triazole-1,3- |
| | diyl; pyrazin-2,5-diyl; and imidazole-2,4-diyl, |
| heterocycloalkyl: | selected from the group consisting of: pyrrolinyl; pyrrolidinyl; |
| | morpholinyl; piperidinyl; piperazinyl; hexamethylene imine; and |
| | oxazolidinyl, |
| amine: | the group —N(R)₂ wherein each R is independently selected from: hydrogen; C1-C6- |
| | alkyl; C1-C6-alkyl-C6H5; and phenyl, wherein when both R are C1-C6- |
| | alkyl both R together may form an —NC3 to an —NC5 heterocyclic ring |
| | with any remaining alkyl chain forming an alkyl substituent to the |
| | heterocyclic ring, |
| halogen: | selected from the group consisting of: F; Cl; Br and I, |
| sulphonate: | the group —S(O)₂OR, wherein R is selected from: hydrogen; C1-C6-alkyl; |
| | phenyl; C1-C6-alkyl-C6H5; Li; Na; K; Cs; Mg; and Ca, |
| sulphate: | the group —OS(O)₂OR, wherein R is selected from: hydrogen; C1-C6-alkyl; |
| | phenyl; C1-C6-alkyl-C6H5; Li; Na; K; Cs; Mg; and Ca, |
| sulphone: | the group —S(O)₂R, wherein R is selected from: hydrogen; C1-C6-alkyl; phenyl; |
| | C1-C6-alkyl-C6H5 and amine (to give sulphonamide) selected from the |
| | group: —NR′2, wherein each R′ is independently selected from: |
| | hydrogen; C1-C6-alkyl; C1-C6-alkyl-C6H5; and phenyl, wherein when |
| | both R′ are C1-C6-alkyl both R′ together may form an —NC3 to an —NC5 |
| | heterocyclic ring with any remaining alkyl chain forming an alkyl |
| | substituent to the heterocyclic ring, |
| carboxylate derivative: | The group —C(O)OR, wherein R is selected from: hydrogen, C1-C6- |
| | alkyl; phenyl; C1-C6-alkyl-C6H5, Li; Na; K; Cs; Mg; and Ca, |
| carbonyl derivative: | the group —C(O)R, wherein R is selected from: hydrogen; C1-C6-alkyl; |
| | phenyl; C1-C6-alkyl-C6H5 and amine (to give amide) selected from the |
| | group: —NR′2, wherein each R′ is independently selected from: |
| | hydrogen; C1-C6-alkyl; C1-C6-alkyl-C6H5; and phenyl, wherein when |
| | both R′ are C1-C6-alkyl both R′ together may form an —NC3 to an —NC5 |
| | heterocyclic ring with any remaining alkyl chain forming an alkyl |
| | substituent to the heterocyclic ring, |
| phosphonate: | the group —P(O)(OR)₂, wherein each R is independently selected from: |
| | hydrogen; C1-C6-alkyl; phenyl; C1-C6-alkyl-C6H5; Li; Na; K; Cs; Mg; |
| | and Ca, |
| phosphate: | the group —OP(O)(OR)₂, wherein each R is independently selected from: |
| | hydrogen; C1-C6-alkyl; phenyl; C1-C6-alkyl-C6H5; Li; Na; K; Cs; Mg; |
| | and Ca, |
| phosphine: | the group —P(R)₂, wherein each R is independently selected from: hydrogen; |
| | C1-C6-alkyl; phenyl; and C1-C6-alkyl-C6H5, |
| phosphine oxide: | the group —P(O)R₂, wherein R is independently selected from: |
| | hydrogen; C1-C6-alkyl; phenyl; and C1-C6-alkyl-C6H5; and amine (to |
| | give phosphonamidate) selected from the group: —NR′2, wherein each |
| | R′ is independently selected from: hydrogen; C1-C6-alkyl; C1-C6-alkyl- |
| | C6H5; and phenyl, wherein when both R′ are C1-C6-alkyl both R′ |
| | together may form an —NC3 to an —NC5 heterocyclic ring with any |
| | remaining alkyl chain forming an alkyl substituent to the heterocyclic |
| | ring. |

Unless otherwise specified the following are more preferred group restrictions that may be applied to groups found within compounds disclosed herein.

Another suitable bleach catalyst is that of formula:

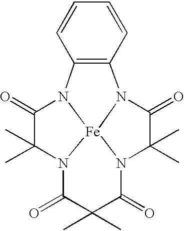

Its axial ligand is chlorine/water or a combination of the two, the counter ion is a metal ion with single positive charge most preferred is lithium.

Another preferred catalyst for use in the present invention is that referred to as [Mn₂(Me₃TACN)₂(m-O)₃(PF₆)₂(H₂O)] and having the formula:

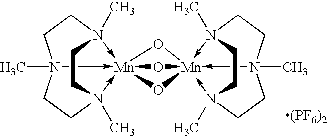

Bleach Catalyst Stabilisers and Performance Enhancers

(i) Acidic Stabilisers

We have found that the presence of an acidic component in an air bleaching composition containing a transition metal catalyst serves to enhance the stability of a transition metal.

Thus, it is especially preferred to disperse the bleach catalyst in a water soluble polymer which is acidic in nature. A preferred polymer of this type is a polyvinyl alcohol copolymer incorporating comonome units having carboxy functionality.

However, whether or not the polymer is acidic in nature, a stabilising acidic component may also be incorporated.

The acidic component according to the present invention may be a water-soluble acidic polymer. The polymer may be used in the compositions according to the present invention to coat, bind or act as cogranulent to the air bleaching catalyst. In a preferred embodiment of the present invention, the air bleaching catalyst, with or without cogranulent, is agglomerated, preferably with a water-soluble acidic polymer.

The binder material and the coating material may be different water-soluble acidic polymers, but alternatively, the binder material and the coating material are the same water-soluble acidic polymer.

The coating agent, a binder and a cogranulent may be regarded as providing overlapping functions. Nevertheless, a single function is all that is required to provide the advantage of the present invention. Obviously, if the acidic component is applied so that all three roles are fulfilled a greater stability may be conferred.

Suitable water-soluble monomeric or oligomeric carboxylate builders include lactic acid, glycolic acid and ether derivatives thereof as disclosed in BE-A-831,368, BE-A-821,369 and BE-A-821,370. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates described in DE-A-2,446,686, and 2,446,687 and U.S. Pat. No. 3,935,257 and the sulfinyl carboxylates described in Belgian Patent No. 840,623. Polycarboxylates containing three carboxy groups include, in particular, water-soluble citrates, aconitrates and citraconates as well as succinate derivatives such as the carboxymethyloxysuccinates described in GB-A-1,379,241, lactoxysuccinates described in British Patent No. 1,389,732, and aminosuccinates described in Netherlands Application 7205873, and the oxypolycarboxylate materials such is 2-oxa-1,1,3-propane tricarboxylates described in GB-A-1,387,447.

Polycarboxylates containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarboxylates. Polycarboxylates containing sulfo substituents include the sulfosuccinate derivatives disclosed in GB-A-1,398,421 and GB-A-1,398,422 and in U.S. Pat. No. 3,936,448, and the sulfonated pyrolysed citrates described in GB-A-1,439,000.

Another preferred polycarboxylate builder is ethylenediamine-N,N′-disuccinic acid (EDDS) or the alkali metal, alkaline earth metal, ammonium, or substituted ammonium salts thereof, or mixtures thereof. Preferred EDDS compounds are the free acid form and the sodium or magnesium salt thereof. Examples of such preferred sodium salts of EDDS include NaEDDS, Na2EDDS and Na4EDDS.

Examples of such other magnesium salts of EDDS include MgEDDS and Mg2EDDS. The magnesium salts are the most preferred for inclusion in compositions in accordance with the invention.

The structure of the acid form of EDDS is as follows:

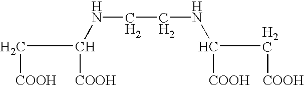

EDDS can be synthesised, for example, from readily available, inexpensive starting material such as maleic anhydride and ethylene diamine. A more complete disclosure of methods for synthesising EDDS from commercially available starting materials can be found in U.S. Pat. No. 3,158,635, Kezerian and Ramsay, issued Nov. 24, 1964.

The synthesis of EDDS from maleic anhydride and ethylene diamine yields a mixture of three optical isomers, [R,R],[S,S), and (S,R], due to the two asymmetric carbon atoms. The biodegradation of EDDS is optical isomerspecific, with the [S,S] isomer degrading most rapidly and extensively, and for this reason the (S,S) isomer is most preferred for inclusion in the compositions of the invention.

The [S,S] isomer of EDDS can be synthesised by heating L-aspartic acid and 1,2-dibromoethane in the presence of sodiun hydroxide. A more complete disclosure of the reaction of L-aspartic acid with 1,2-dibromoethane to form the (S,S) isomer of EDDS can be found in Neal and Rose, Stereospecific Ligands and Their Complexes of Ehtylenediaminediscuccinic Acid, Inorganic Chemistry, Vol 7 (1968), pp. 2405-2412.

Alicyclic and heterocyclic polycarboxylates include cyclopentane-cis,cis,cis-tetracarboxylates, cyclopentadienide pentacarboxylates, 2,3,4,5-tetrahydrofuran—cis, cis, cis-tetracarboxylates, 2,5- tetrahydrofuran—cis—dicarboxylates, 2,2,5,5- tetrahydrofuran—tetracarboxylates, 1,2,3,4,5,6-hexane—hexacarboxylates and carboxymethyl derivatives of polyhydric alcohols such as sorbitol, mannitol and xylitol. Aromatic polycarboxylates include mellitic acid, pyromellitic acid and the phthalic acid derivatives disclosed in GB-A-1,425,343. Of the above, the preferred polycarboxylates are hydroxycarboxylates containing up to three carboxy groups per molecule, more particularly citrates.

The parent acids of the monomeric or oligomeric polycarboxylate chelating agents or mixtures thereof with their salts, e.g. citric acid or citrate/citric acid mixtures are also contemplated as components of builder systems of detergent compositions in accordance with the present invention.

Other suitable water soluble organic salts are the homo- or co-polymeric polycarboxylic acids or their salts in which the polycarboxylic acid comprises at least two carboxyl radicals separated from each other by not more than two carbon atoms. Polymers of the latter type are disclosed in GB-A-1,596,756. Examples of such salts are polyacrylates of MWt 2000 to 5000 and their copolymers with maleic anhydride, such copolymers having a molecular weight of from 20,000 to 70,000, especially about 40,000.

Such builder polymeric materials may be identical to the polymeric materials as binder materials and coating materials, as described hereinabove. These materials are normally used at levels of from 0.5% to 10% by weight more preferably from 0.75% to 8%, most preferably from 1% to 6% by weight of the composition.

Organic phosphonates and amino alkylene poly (alkylene phosphonates) include alkali metal ethane 1-hydroxy diphosphonates, nitrilo trimethylene phosphonates, ethylene diamine tetra methylene phosphonates and diethylene 1,12 triamine pentamethylenephosphonates, although these materials are less preferred where the minimisation of phosphorus compounds In the compositions is desired.

Suitable polymers for use herein are water-soluble. By water-soluble, it is meant herein that the polymers have a solubility greater than 5 g/l at 20° C.

Suitable polymers for use herein are acidic. By acidic, it is meant herein that a 1% solution of said polymers has a pH of less than 7, preferably less than 5.5.

Suitable polymers for use herein have a molecular weight in the range of from 1000 to 280,000, preferably from 1500 to 150,000, preferably, suitable polymers for use herein have a melting point above 30° C.

Suitable polymers which meet the above criteria and are therefore particularly useful in the present invention, include those having the following empirical formula I

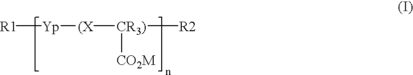

wherein X is 0 or CH2; Y is a comonomer or comonomer mixture; R1 and R2 are bleach-stable polymer-end groups; R3 is H, OH or C1-4 alkyl; M is H, and mixtures thereof with alkali metal, alkaline earth metal, ammonium or substituted ammonium; p is from 0 to 2; and n is at least 10, and mixtures thereof. The proportion of M being H in such polymers must be such as to ensure that the polymer is sufficiently acidic to meet the acidity criteria as hereinbefore defined.

Polymers according to formula I are known in the field of laundry detergents, and are typically used as chelating agents, as for instance in GB-A-1,597,756. Preferred polycarboxylate polymers fall into several categories. A first category belongs to the class of copolymeric polycarboxylate polymers which, formally at least, are formed from an unsaturated polycarboxylic acid such as maleic acid, citraconic acid, itaconic acid and mesaconic acid as first monomer, and an unsaturated monocarboxylic acid such as acrylic acid or an alpha —C1-C4 alkyl acrylic acid as second monomer. Referring to formula 1, therefore, preferred polycarboxylate polymers of this type are those in which X is CHO, R3 is H or C1-4 alkyl, especially methyl, p is from about 0.1 to about 1.9, preferably from about 0.2 to about 1.5, n averages from about 10 to about 1500, preferably from about 50 to about 1000, more preferably from 100 to 800, especially from 120 to 400 and Y comprises monomer units of formula II

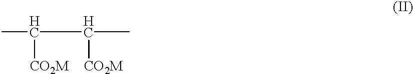

Such polymers are available from BASF under the trade name Sokalan® CP5 (neutralised form) and Sokajan® CP45 (acidic form).

A second category belongs to the class of polycarboxylate polymers in which referring to formula I, X is CH2, R3 is OH, p is from 0 to 0.1, preferably 0 and n averages from about 50 to about 1500, preferably from about 100 to 1000.

Y, if present, can be a polycarboxylic acid such as 11 above, or an ethylene oxide moiety.

A third category belongs to the class of acetal polycarboxylate polymers in which, referring to formula I, X is (OR4)2, where R4 is Cl-C4 alkyl, R3 is H, p is from 0 to 0.1, preferably 0 and n averages from 10 to 500. If present, Y again can be a polycarboxylic acid such as II above or an ethyleneoxide moiety.

A fourth category belongs to the class of polycarboxylate polymers in which referring to formula I, X is CH2, R3 is H or C1-4 alkyl, p is 0 and n averages from about 10 to 1500, preferably from about 500 to 1000.

A fifth category of polycarboxylate polymers has the formula I in which X is CH2, R3 is H or C1-4 alkyl, especially methyl, p is from 0.01 to 0.09, preferably from 0.02 to 0.06, n averages from about 10 to about 1500, preferably from about 15 to about 300 and Y is a polycarboxylic acid formed from maleic acid, citraconic acid, mitaconic acid or mesaconic acid, highly preferred being maleic acid-derived comonomers of formula II above.

Suitable polymer end groups in formula I suitably include alkyl groups, oxyalkyl groups and alkyl carboxylic acid groups and salts and esters thereof.

In formula I above, M is H or mixtures thereof with alkali metal, alkaline earth metal, ammonium or substituted ammonium. The proportion of M which is H is such as to ensure that the polymer meets the pH criteria described herein above.

In the above, n, the degree of polymerization of the polymer can be determined from the weight average polymer molecular weight by dividing the latter by the average monomer molecular weight. Thus, for a maleic-acrylic copolymer having a weight average molecular weight of 15,500 and comprising 30 mole % of maleic acid derived units, n is 182 (i.e. 15,00/(116×0.3+72×0.7).

In case of doubt, weight-average polymer molecular weights can be determined herein by gel permeation chromatography using Water [mu] Porasil (RTM) GPC 60 A2 and (mu) Bondagel (RTM) E-125, E-500 and E-1000 in series, temperature- controlled columns at 40° C. against sodium polystyrene sulphonate polymer standards, available from Polymer Laboratories Ltd., Shropshire, UK, the polymer standards being 0.15M sodium dihydrogen phosphate and 0.02M tetramethyl ammonium hydroxide at pH 7.0 in 80/20 water/acetonitrile.

Mixtures of polycarboxylate polymers are also suitable herein, especially mixtures comprising a high molecular weight component having an n value of at least 100, preferably at least 120, and a low molecular weight component having an n value of less than 100, preferably from 10 to 90, more preferably from 20 to 80. Such mixtures are optimum from the viewpoint of providing excellent bleach stability and anti-incrustation performance in the context of a zerophosphate detergent formula.

In mixtures of this type, the weight ratio of high molecular weight component to low molecular weight component is generally at least hi, preferably from about 1:1 to about 20:1, more preferably from about 1.5:1 to about 10.1, especially from about 2:1 to about 8:1.

Preferred polycarboxylate polymers of the low molecular weight type are polycarboxylate polymers of the fourth category (homopolyacrylate polymers) listed above.

Of all the above, highly preferred polycarboxylate polymers herein are those of the first category in which n averages from 100 to 800, preferably from 120 to 400 and mixtures thereof with polycarboxylate polymers of the fourth category in which n averages from 10 to 90, preferably from 20 to 80.

Other suitable polymers for use herein include polymers derived from amino acids such as polyglutamine acid, as disclosed in co-pending application GB 91-20653.2, and polyaspartic acid, as disclosed in EP 305 282, and EP 351 629.

Alternatively, the binder component may be a component together with an acid e.g., polyvinyl alcohol and a liquid acid.

(ii) Antioxidant Enhancers

We have also found that in some instances an organic substance having an unsaturated bond is degraded by the air bleaching catalyst in a non-desirable way e.g. producing malodours. A solution to this problem is provided by the presence of an antioxidant, the presence of which still permits air bleaching of stains.

The unsaturated organic compound may be unsaturated compound dispersed in the polymer itself and/or forming a component encapsulated in a film made from the polymer. Examples of such materials are unsaturated soaps or unsaturated cationic detergents, either or both optionally being present. In addition, or in the alternative, the unsaturated organic compound may be present as part of the soil being removed during use of the product, e.g. a component of human sweat.

The polymer may comprise an effective amount of the anti-oxidant, preferably from about 0.001% more preferably from about 0.1%, most preferably from about 0.2% to about 10%, preferably to about 5%, more preferably to about 1% by weight of an anti-oxidant. Anti-oxidants are substances as described in Kirk-Othmers (Vol 3, pg 424) and in Uhlmans Encyclopedia (Vol 3, pg 91).

One class of anti-oxidants suitable for use in the present invention is alkylated phenols having the general formula:

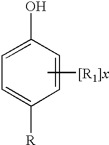

wherein R is C1-C22 linear or branched alkyl, preferably methyl or branched C3-C6 alkyl; C3-C6 alkoxy, preferably methoxy; R1 is a C3-C6 branched alkyl, preferably tert-butyl; x is 1 or 2. Hindered phenolic compounds are preferred as antioxidant.

Another class of anti-oxidants suitable for use in the present invention is a benzofuran or benzopyran derivative having the formula:

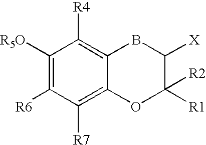

wherein R1 and R2 are each independently alkyl or R1 and R2 can be taken together to form a C5-C6 cyclic hydrocarbyl moiety; B is absent or CH2; R4 is C1-C6 alkyl; R5 is hydrogen or —C(O)R3 wherein R3 is hydrogen or C1-C19 alkyl; R6 is C1-C6 alkyl; R7 is hydrogen or C1-C6 alkyl; X is —CH2OH, or —CH2A wherein A is a nitrogen comprising unit, phenyl, or substituted phenyl. Preferred nitrogen comprising A units include amino, pyrrolidino, piperidino, morpholino, piperazino, and mixtures thereof.

Other suitable antioxidants are found as follows. A derivative of α-tocopherol, 6-hydroxy-2,5,7,8-tetra-methylchroman-2-carboxylic acid (Trolox™). Anti-oxidants/radical scavengers such as ascorbic acid (vitamin C) and its salts, tocopherol (vitamin E), tocopherol sorbate, other esters of tocopherol, butylated hydroxy benzoic acids and their salts, gallic acid and its alkyl esters, especially propyl gallate, uric acid and its salts and alkyl esters, sorbic acid and its salts, the ascorbyl esters of fatty acids, amines (e.g., N,N-diethylhydroxylamine, amino-guanidine), sulfhydryl compounds (e.g., glutathione), and dihydroxy fumaric acid and its salts may be used.

Non-limiting examples of anti-oxidants suitable for this use include phenols inter alia 2,6-di-tert-butylphenol, 2,6-di-tert-butyl-4-methylphenol, mixtures of 2 and 3- tert-butyl-4-methoxyphenol, and other ingredients including include propyl gallate, tert-butylhydroquinone, benzoic acid derivatives such as methoxy benzoic acid, methylbenzoic acid, dichloro benzoic acid, dimethyl benzoic acid, 5-hydroxy-2,2,4,6,7- pentamethyl-2,3-dihydro-1-benzofuran-3-one, 5-hydroxy-3-methylene-2,2,4,6,7-pentamethyl-2,3-dihydro-benzofuran, 5-benzyloxy-3-hydroxymethyl-2,2,4,6,7-pentamethyl-2,3-dihydro-1-benzofuran, 3-hydroxymethyl-5-methoxy-2,2,4,6,7-pentamethyl-2,3-dihydro-1-benzofuran, vitamin C(ascorbic acid), and Ethoxyquine (1,2-dihydro-6-ethoxy-2,2,4-trimethylchinolin)marketed under the name Raluquin™ by the company Raschig™.

Preferred radical scavengers for use herein include di-tert- butyl hydroxy toluene (BHT), α-tocopherol. hydroquinone, 2,2,4-trimethyl-1,2-dihydroquinoline, di-tert-butyl hydroquinone, mono-tert-butyl hydroquinone, tert-butyl-hydroxy anisole, benzoic acid and derivatives thereof, like alkoxylated benzoic acids, as for example, trimethoxy benzoic acid (TMBA), toluic acid, catechol, t-butyl catechol, benzylamine, 1,1,3-tris(2-methyl-4-hydroxy-5-t-butylphenyl) butane, N-propyl-gallate or mixtures thereof and highly preferred is di-tert-butyl hydroxy toluene.

The Unsaturated Organic Compound

The following is intended as a general example of unsaturated groups that may be present. There are many classes of unsaturated compounds that will work with the present invention to enhance air bleaching. More specifically unsaturated organic substances are preferred which contains one or more allylic moieties. As one skilled in the art is aware unsaturated compounds (enhancers) may be found in: charged species, neutral species, cationic species, anionic species, and zwitterionic species.

One skilled in the art will appreciate that benzene is considered unsaturated but does not contain allylic hydrogens per se. The homolytic bond dissociation energy (BDE) for benzene (C6H5-H) is 110.9 kcal/mol (298 K) makes benzene unsuitable to promote enhanced bleaching and resistant to autoxidization. The preferred unsaturated compound has a hydrogen atom covalently bound to an alpha-carbon that is alpha to a Sp2-Sp2 hybridized bond e.g., as shown as underlined in the following formula CH2=CH—CH2-CH3. It is most preferred that the enhancer has a molecular weight of at least 80 and a bond dissociation energy of less than 95 kcal/mol, most preferably below 90 kcal/mol, and even more preferred below 85 kcal/mol. Below is a table of bond strengths (298 K) obtained from: The handbook of Chemistry and Physics 73^{rd} edition, CRC Press. The Table serves to illustrate that a benzylic or hydrogen alpha to an ether linkage will likely serve as an enhancer to air bleaching.

| Compound | BDE ΔH(kcal/mol) |
|---|---|
| (CH3)3CH | 93.3 ± 0.5 |
| H—CH2OCH3) | 93 ± 1 |
| C6H5—H | 110.9 ± 2.0 |
| H—CMe2OH | 91 ± 1 |
| CH3CH3 | 100.3 ± 1 |
| CH2═CH—CH2—CH3 | 83.1 ± 2.2 |
| CH2═CH—CH3 | 86.3 ± 1.5 |
| C6H5—CH3 | 88.0 ± 1 |
| CH3CH═CHCH═CH2 | 83 ± 3 |

1) Unsaturated Soap (Unsaturated Anionic)

Any unsaturated fatty acid soap used preferably contains from about 16 to about 22 carbon atoms, preferably in a straight chain configuration. Preferably the number of carbon atoms in the unsaturated fatty acid soap is from about 16 to about 18.

This unsaturated soap, in common with other anionic detergents and other anionic materials in the detergent compositions of this invention, has a cation, which renders the soap water-soluble and/or dispersible. Suitable cations include sodium, potassium, ammonium, monethanolammonium, diethanolammonium, triethanolammonium, tetramethylammonium, etc. cations. Sodium ions are preferred although in liquid formulations potassium, monoethanolammonium, diethanolammonium, and triethanolammonium cations are useful.

The unsaturated soaps are made from natural oils that often contain one or more unsaturated groups and consist of mixtures of components. It is clear that hydrolysation of these natural components yield mixtures of soaps, of which at least one of the components contain one or more unsaturated groups. Examples of natural oils are sunflower oil, olive oil, cottonseed oil, linseed oil, safflower oil, sesame oil, palm oil, corn oil, peanut oil, soybean oil, castor oil, coconut oil, canola oil, cod liver oil and the like, that give mixtures of soaps of which at least one of them has at least unsaturated group. However, also hydrolysis products of purified oils, as listed above, may be employed. Other examples of soaps include erucic acid,

2) Unsaturated Surfactant (Unsaturated Cationic)

As one skilled in the art will appreciate such an unsaturated cationic may be manufactured, for example, by adding an unsaturated alkyl halide to an amine thus forming an unsaturated cationic.

In principle the cationic surfactants exhibit the same requirements as listed above for the unsaturated soap materials, except they need to be quarternised. Without limiting the scope of the invention, suitable cationics may be formed by preparing the quaternary salts from alcohols that were obtained from the corresponding fatty acid (as defined under 1; from oils containing unsaturated bonds). Examples of cationic surfactants based on natural oils include oleylbis(2-hydroxyethyl)methylammonium chloride and ditallow fatty alkyldimethyl ammonium chloride.

3) Other Unsaturated Organic Compounds

One relatively cheap source unsaturated compounds are polyunsaturated fatty acids (PUFA), which are primarily found in vegetable oils and fish sources. Examples of such are: sunflower oil, olive oil, cottonseed oil, fish oil, linseed oil, safflower oil, sesame oil, palm oil, corn oil, peanut oil, soybean oil, and castor oil, coconut oil, canola oil, tallow, cod liver oil and the like.

Another class of molecules containing unsaturated bonds are sulfates-, sulfonates-, ether-sulfonate- and estersulfonates- containing molecules having one or more unsaturated bonds. An examples include alpha-olefin C14-C16 sulfonate (ex Witco).

Another class of molecules containing unsaturated bonds are esters or amides based on the soaps (fatty acids) as defined above. Examples include, methyl oleate, methyl ester of tallow fatty acids, oleamides,

Polymers having unsaturated bonded may be used. Examples of suitable polymers include 1,4-polybutadiene, 1,2-polybutadiene, 1,4-polyisoprene, 3,4-polyisoprene, and copolymers of polybutadiene and isoprene with vinyl aromatic monomers such as styrene, α-methyl styrene, vinyl naphthalene, vinyl anthracene and copolymers of butadiene and isoprene with acrylonitrile, acrylates, and the like. Also, the unsaturated polymers derived from mono-olefinic monomers exemplified by norborene. Polypiperylene and copolymers of piperylene with vinyl aromatic, acrylonitrile and acrylate monomers exemplify other polymers having olefinic double bonds in their structures.

To benefit from the enhancement of bleaching activity it is preferred that the unsaturated organic compound is present in the composition such that a unit dose provides at least 0.1 g/l concentration of the unsaturated organic compound in a wash. The organic unsaturated compound may be present in the composition in the range of 0.1 to 20%, preferably 5 to 15% and most preferably 10% w/w.

In contrast to the above the unsaturated organic compound may be found in the wash and may originate from sources other than the detergent composition. The unsaturated organic compound may be present as a result of body secretions or from some other source.

A review by Nicolaides in Science 186, 19-26; 1974, entitled ‘Skin Lipids: Their Biochemical Uniqueness’) discusses of body secretions. The single most abundant unsaturated component of skin lipid is squalene, a polunsaturated (6 double bonds) hydrocarbon isoprenoid which is the classical unique marker lipid for sebum. The largest bulk components of skin lipid are fatty acids (FAs), present in both esterified & unesterified forms. Originally, most, if not all, of these are esterified (mainly as triglycerides in sebum) but, due the action of microbial lipases, most are hydrolysed to free FAs, either in the hair follicle or on the skin surface. This tends to make the unsaturated FAs more prone to oxidation. According to Nicolaides, approximately 50% of the FAs of skin lipid are unsaturated, mostly monoenes (ca. 47%), but also dienes (ca. 3%). Of the monoenes, the most abundant are hexadec-6-enoic and hexadec-8-enoic acids. The most abundant dienes are octadeca-5,8-dienoic (sebaleic) and octadeca-9,12-dienoic (linoleic) acids.

There are many other sources of unsaturated organic compounds or other organic compounds that may benefit from the presence of an antioxidant in the wash. Hence the present invention should be regarded as a method of reducing the degradation of such.

An unsaturated organic may be provided at a later stage in the wash process for example from a fabric conditioner. Unsaturated compounds present in a fabric conditioner are discussed in PCT/GB00/0169 and referenced found therein.

(b) Bleach Activators

Bleach activators are materials which react in the wash with peroxygen bleach salts to form an active bleaching species. Preferred examples of such activators are tetra acetyl ethylene diamine (TA ED) and sodium monyloxy bencoate.

Examples of other suitable bleach precursor include cationic - nitrites, such as: the N-alkyl-ammonium acetonitriles, described in EP-A-0 303 520, EP-A-0 458 396, EP-A-0 464 880, WO 96/40661, WO 98/23533, DE 196 29 159 and EP-A-0 790 244 and the cyanopyridinium and pyridine-N-oxide compounds disclosed in EP-A-0 806 473 and EP-A-0 819 673. Similarly useful cyano activator compounds are disclosed in EP-A-0 819 673 and DE 196 09 955. Imines such as the sulfonimines described in U.S. Pat. No. 5,041,232, US-A- and U.S. Pat. No. 5,047,163, and quaternary imine salts (imine quats). The imine quats are generally described and many specific examples given in U.S. Pat. No. 5,360,568, U.S. Pat. No. 5,360,569 and U.S. Pat. No. 5,478,357. Further examples thereof are described in WO 96/34937, WO 97/10323, WO 98/16614 and U.S. Pat. No. 5,710,116.

Preferred inclusion levels of activators are 0.01% to 50%, more preferably 0,04% to 40% by weight of total activtor plus the polymer.

(c) UV Absorbers

The UV absorbers are typically selected from flourescers, photofading inhibitors such as sunscreens/UV inhibitors, and/or anti-oxidants.

When present, the total amount of UV absorber is preferably from 0.04% to 40%, more preferably from 0.05% to 25% by weight of total UV absorber plus the polymer.

Preferred UV absorbers are selected from those disclosed in “Formulating Detergents and Personal Care Products” by Ho Tan Tai, ISBN 1-893997-10-3, pages 122-137.

Suitable photofading inhibitors of the sunscreen/UV inhibitor type are preferably molecules with an extinction co-efficient greater than 2000 1 mol⁻¹ cm⁻¹ at a wavelength of maximal absorption. Typically for a sunscreen maximal absorption occurs at wavelengths of 290-370 nm, more usually 310-350 nm, especially 330-350 nm.

Examples of suitable sunscreens are given in Cosmetic Science and Technology Series, Vol. 15; Sunscreens; 2^{nd} edition; edited by Lowe, Shoath and Pathak; Cosmetics and Toiletries; Vol. 102; March 1987; pages 21-39; and Evolution of Modern Sunscreen Chemicals; pages 3-35 both by N. A. Saarth.

In particular, suitable sunscreens include carboxylic acids or carboxylic acid derivatives, for example acrylates, cinnamates and benzoates or derivatives thereof, such as 4-methoxy cinnamate salicylates, PABA, 4-acetoxy benzoate dibenzoylmethanes, phenyl benzoimidazoles, aminobenzoates, benzotriazoles and benzophenones.

Suitable photofading inhibitors of the anti-oxidant type include benzofurans, coumeric acids or derivatives thereof, for example 2-carboxy benzofuran and bis(p-amine sulphonates) triazine, DABCO derivatives, tocopherol derivatives, tertiary amines and aromatic substituted alcohols e.g., butylated hydroxytoluene (BHT), Vitmin C (ascorbic acid) and vitamin E.

(d) Fibre Damage Inhibitors

Fibre Damage Inhibitors may for example be selected from fabric softenining clays as disclosed in EP-A-0 652 282.

When present, the total amount of fibre damage inhibitor is preferably from 0.04% to 25%, preferably from 0.05% to 10% by weight of total inhibitor to the polymer.

Another class of such inhibitors are the crystalline sheet silicas or silicates of the general formula ABSixO2x−1·yH2O where A, B=Na, K or H, x=7 to 30, y=0 to 30, exhibit in the X-ray diffraction diagram one or more reflections in the range of d values from 3.0 to 4.0×10-8 cm which cannot be attributed to quartz, tridymite or cristobalite described in EP-A-0 640 683.

Another class of such inhibitors are cyclic amine compounds described in EP0585039 quaternary ammonium materials having two C12-28 alkyl or alkenyl groups connected via an ester link to a hydrocarbon chain which is connected to the quaternary nitrogen atom described in EP-A-0 585 040.

(e) Colour Care Additives

Colour care additives are typically selected from one or more materials which are dye fixatives and/or anti-dye transfer agents. Such colour care additives form another particularly preferred class of variants of the present invention.

When present, the total amount of colour care additives is from 0.04% to 40%, preferably from 0.4% to 25% by weight of such addition plus the polymer.

Colour care agents are dye fixatives and anti-dye transfer agents. A wide range of these are known in the art. However, preferably they are cationic polymers or copolymers. Preferred for use as possible auxiliaries in the present invention are polymers and copolymers contain at least one dye binding monomer and optionally, at least one anionic monomer.

In the context of the present invention, a dye binding monomer is defined as a monomer the homopolymer (mwt of which 40,000-100,000) of which binds dye in water at pH 9 at a temperature from 5° C. to 60° C., preferably at a temperature of 20° C. However, with this proviso the dye binding homopolymer can bind dye under other conditions.

Any dye binding monomer is suitable for use with the present invention, however it is preferred if the dye binding monomer comprises a nitrogen containing heterocycle.

Preferred dye binding monomers include vinyl azlactone, vinyl azlactam, more preferred polymers include vinyl pyrrolidone (VP), vinyl imidazole (VI), vinyl pyridine, vinyl pyridine-N-oxide (VPy-N-O), vinyl oxazolidone. Especially preferred are vinyl imidazole and vinyl pyridine-N-oxide, used alone or in combination with vinyl pyrolidone and combinations thereof. Especially preferred are those polymers and copolymers wherein no optional anionic comonomer is present.

Any anionic monomer is suitable as an optional anionic comonomer, although presence of these is less preferred, when present. However it is preferred if the anionic moiety is based on a carboxy, sulphonate, sulphate, phosphate or phosponate containing material, especially preferred are short chain, polymerisable group carboxy containing material having at least one double bond. Preferred anionic monomers are itaconic acid, aconitic acid, mesaconic acid, citraconic acid, acrylic acid (AA), methacrylic acid (MA), vinyl acetic acid, vinyl benzoic acid, vinyl sulphonic acid, vinyl benzene sulphonic acid, vinyl phospheric acid and hydroxy acrylic acid. Especially preferred are AA, MA and vinyl sulphonic acid.

Examples of preferred copolymers are described below.

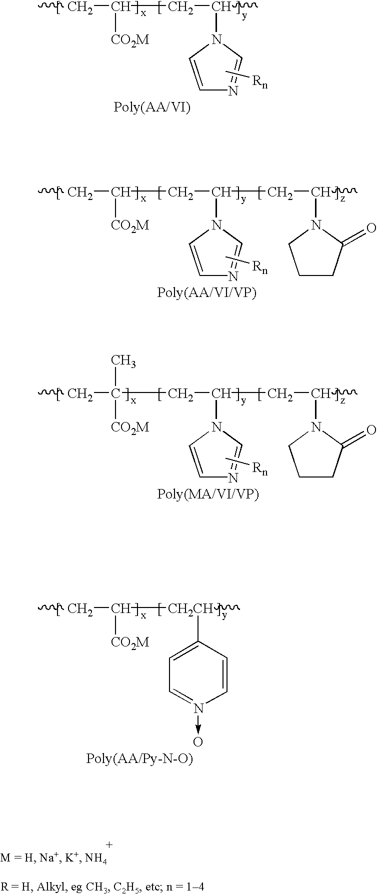

In the case of such copolymers, the ratio of anionic monomer to the dye binding monomer within the co-polymer is preferably from 1:200 to 1:1, more preferably 1:150 to 1:2, most preferably 1:100 to 1:3.

It may be desirable to include additional monomers in these dye binding polymer. Examples of these additional monomers include vinyl alcohol, vinyl acetate, polyethylene glycol (PEG), vinyl styrene, acrylamide, methyl methacrylate, hydroxyethyl acrylate/methacrylate, IEG acrylate/methacrylate, glycidyl acrylate/methacrylate. The addition of these third monomemers can cause changes in the properties of these polymers such as solubility, compatibility with liquid products and redeposition performance or sequestration ability.

Additional monomers may also be present for cost minimalisation, as a cross-linking moiety or to impart biodegradability.

It is preferred if the polymer or co-polymer has an average molecular weight range from 2,000 to 200,000 more preferably from 5,000 to 100,000, most preferably from 5,000 to 70,000.

When copolymers with anionic monomers are utilised, preferably are selected from the group consisting of:

a) co-polymers of PVP/PVI/AA, PVP/PVI/MA especially where the ratio of PVI/PVP is from 2 to 0.2, most preferably 1 to 0.3.

b) co-polymers of PVI/AA, PVI/MA and:

c) co-polymers of PVPy-N-O/M, PVPy-N-O/MA.

(f) Fibre Interactive Polymers

Polymers which are fibre interactive can be regarded as falling into three classes, namely soil release polymers, fibre rebuild agents and deposition aids. The mechanism of action each of these will now be explained briefly.

When present, the total amount of fibre interactive polymers is from 0.04% to 40%, preferably from 0.4% to 25% by weight of such polymers plus the water soluble polymer.

In summary, these polymers exert their effect by having an affinity (substantivity) for a textile fabric substrate. In general, they contain moieties having a structure which is chemically “philic” with respect to the substrate material, e.g. having structural similarity therewith. Normally, they are either adapted to be substantive to relatively hydrophilic fibres, which in practice, normally means cotton, or to relatively hydrophobic fibres which are normally synthetic, often polyester.

Fibre rebuild agents are used to provide appearance and integrity benefits to fabrics, for example to repair or slow fibre damage caused by wash or wear.

Deposition acids utilise their substantivity to the fabric to deposit thereon, moieties which deliver a benefit such as those provided by other cleaning agent auxiliaries referred to in this specification. They comprise a chemical group or groups which are substantive to the substrate and one or more groups providing the benefit.

Amongst the most common commercially used soil release polymers are the sulphonated and unsulphonated polyesters. Examples include polyethylene terephthalate/polyoxyethylene terephthalate (PET/POET) polyesters, both end-capped and non-end-capped, for example the Repel-0-Tex (Trade Mark) series of polymers ex Rhodia Chimie, and TexCare SRA 100 (Trade Mark) ex Clariant. Another class of polymers effective both for soil release and for preventing soil redeposition are polyethylene glycol/polyvinyl alcohol graft copolymers such as Sokalan (Trade Mark) HP22 ex BASF. Especially preferred soil release polymers are the sulphonated non-end-capped polyesters described and claimed in WO-A-95/32997. Mixtures of two or more soil release polymers, whether of the polyester type or otherwise, may be included.

The term “soil release polymer” is used in the art to cover polymeric materials which assist release of soil from fabrics, e.g. cotton or polyester based fabrics. For example, it is used in relation to polymers which assist release of soil direct from fibres. It is also used to refer to polymers which modify the fibres so that dirt adheres to the polymer-modified fibres rather than to the fibre material itself. Then, when the fabric is washed the next time, the dirt is more easily removed than if it was adhering the fibres. Although not wishing to be bound by any particular theory or explanation, the inventors believe that the soil release polymers utilised in the present invention probably exert their effect mainly by the latter mechanism.

(a) one or more anionic monomer units;

(b) one or more cationic monomer units; and

(c) optionally, one or more uncharged monomer units.

Preferably, the number ratio of the total of all negative charges on the anionic monomer unit(s) to the total of all positive charges on the cationic monomer unit(s) is from 10:1 to 3:1, especially from 17:3 to 3:1.

The anionic monomer unit(s) (a) is/are selected from those of formula (A)

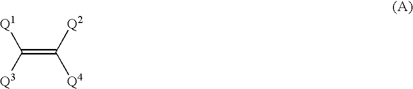

wherein at least two of Q¹-Q⁴ are independently selected from hydrogen and methyl;

either one or two of Q¹-Q⁴ are independently selected from anionic groups, preferably of formula:

Q⁵-Q⁶-Y

wherein either or both of Q⁵ and Q⁶ is/are absent, Q⁵ otherwise representing -Ph-, —CO—, —CH₂=CH₂, —CONH— or —CO—O— and Q⁶ otherwise representing a C₁₋₄ alkylene linkage, one or more of the hydrogen atoms of which is independently optionally substituted by an —OH group or a group —Y;

Y is selected from groups of formula —CO₂H, —SO₃H, —OSO₃H, —PO₄H, —PO₃H, —OPO₃H₂ and —OPO₃H₃;

and in the case where two only of Q¹-Q⁴ are independently hydrogen or methyl and only one of Q¹-Q⁴ is -Q⁵-Q⁶-Y, then the remaining group of Q¹-Q⁴ can be any other compatible uncharged group, for example aliphatic, aromatic or mixed aliphatic-aromatic groups having from 2 to 20 carbon atoms (optionally also containing one or more heteroatoms) such as C₂-₂₀ alkyl groups, C₅₋₁₂ cycloalkyl groups, C₅₋₉ aryl groups, C₁₋₈ alkyl-C₅₋₉ aryl groups, any cycloalkyl or aryl group optionally containing one or two heteroatoms independently selected from nitrogen, oxygen and sulphur.

The cationic monomer unit(s) (b) is/are independently selected from one or more units derived from compounds of formulae (I) to (III):—

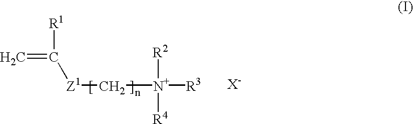

in which:

R¹ is a hydrogen atom or a methyl group, preferably a methyl group;

R², R³ and R⁴ are linear or branched C₁-C₆ alkyl groups;

n is from 1 to 4, in particular the number 3;

Z¹ is a group —C(O)O, —C(O)NH— or —O—; and

X⁻ is a counterion compatible with the water-soluble nature of the polymer;

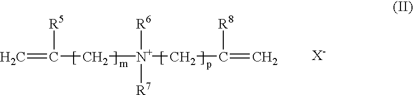

in which:

R⁵ and R⁸ are, independently hydrogen, or a linear or branched C₁-C₆ alkyl group;

R⁶ and R⁷ are independently represent alkyl, hydroxyalkyl or aminoalkyl group in which the alkyl group is a linear or branched C₁-C₆ chain, preferably a methyl group;

m and p are independently from 1 to 3; and

X⁻ is as defined in formula (I); and

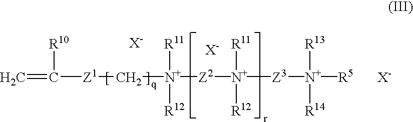

in which:

R⁹ is hydrogen, methyl or ethyl;

R¹⁰, R¹¹, R¹², R¹³ and R¹⁴ independently selected from groups as defined for R⁶ and R⁷ in formula(II);

q is from 0 to 10, preferably from 0 to 2;

r is from 0 to 6, preferably from 1 to 6, more preferably from 2 to 4;

Z¹ is as defined in formula (I);

Z² represents a (CH₂)ₛ group, s being from 1 to 6, preferably from 2 to 4;

Z³ is a linear or branched C₂- C₁₂, advantageously C₃- C₆, polymethylene chain optionally interrupted by one or more heteroatoms or heterogroups, in particular O or NH, and optionally substituted by one or more hydroxyl or amino groups, preferably hydroxyl groups; and

X⁻, is as defined in formula (I); and from those having a cyclic moiety with an N⁺ atom.

The unchanged monomer unit(s) (c) is/are selected from

(i) hydrophilic neutral monomers such as (meth)acrylamide and their N-monosubstituted or N,N-disubstituted versions (such as N-isopropylacrylamide, N-butylacrylamide and N,N-dimethylacrylamide), vinyl formamide, vinyl pyrrolidone, alkoxylated (meth)acrylate, such as hydroxyethyl(meth)acrylate, hydroxypropyl(meth)acrylate, and their higher ethoxylated or propoxylated versions such as behenyl polyethoxy methacrylate of formula (V):

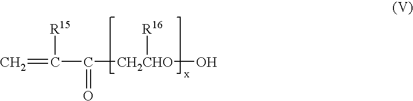

wherein R¹⁵ is hydrogen, or methyl and R¹⁶ is hydrogen, methyl or ethyl, and X is from 1 to 150;

(ii) hydrophobic neutral monomers such as vinyl acetate and its higher homologs, alkyl(meth)acrylates (e.g. methyl methacrylate, butyl acrylate and ethyl acrylate), styrene and its derivatives, methyl vinyl ether, Sipomer WAM and WAM II from Rhodia, glycidyl methacrylate; and

(iii) hydrophilic neutral monomers with potentially cationic functional groups.

Suitable fibre rebuild agents are disclosed in WO-A-98/29528, WO-A-99/14245, WO-A-99/14295 and WO 00/18860. Typically, these materials are cellulosic polymers of formula (I)

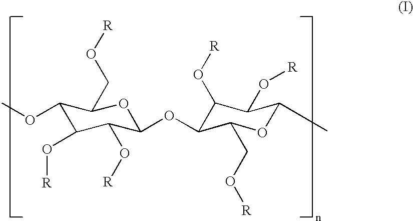

wherein at least one or more R groups of the polymer are independently selected from groups of formulae:—

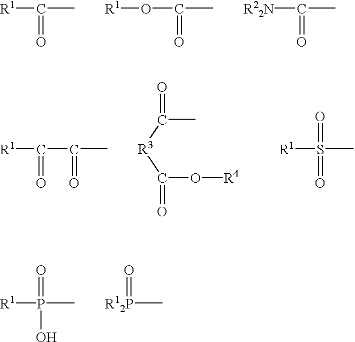

wherein each R¹ is independently selected from C₁₋₂₀ (preferably C₁₋₆) alkyl, C₂₋₂₀ (preferably C₂₋₆) alkenyl (e.g. vinyl) and C₅₋₇ aryl (e.g. phenyl) any of which is optionally substituted by one or more substituents independently selected from C₁₋₄ alkyl, C₁₋₁₂ (preferably C₁₋₄) alkoxy, hydroxyl, vinyl and phenyl groups;

each R² is independently selected from hydrogen and groups R¹ as hereinbefore defined;

R³ is a bond or is selected from C₁₋₄ alkylene, C₂₋₄ alkenylene and C₅₋₇arylene (e.g. phenylene) groups, the carbon atoms in any of these being optionally substituted by one or more substituents independently selected from C₁₋₁₂ (preferably C₁₋₄) alkoxy, vinyl, hydroxyl, halo and amine groups;

each R⁴ is independently selected from hydrogen, counter cations such as alkali metal (preferably Na) or ½ Ca or ½ Mg, and groups R¹ as hereinbefore defined; and

groups R which together with the oxygen atom forming the linkage to the respective saccharide ring forms an ester or hemi-ester group of a tricarboxylic- or higher polycarboxylic- or other complex acid such as citric acid, an amino acid, a synthetic amino acid analogue or a protein.

The groups R may also fulfil any of the definitions (a) or (b)

(a) each R is independently selected from the group consisting of

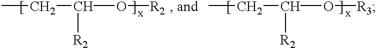

each R₂ is independently selected from the group consisting of H and C₁-C₄ alkyl;

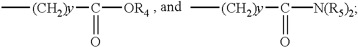

each R₃ is independently selected from the group consisting of

wherein:

each R₄ is independently selected from the group consisting of H, C₁-C₂₀ alkyl, C₅-C₇ cycloalkyl, C₇-C₂₀ alkylaryl, C₇-C₂₀ arylalkyl, substituted alkyl, aminoalkyl, alkylaminoalkyl, dialkylaminoalkyl, piperidinoalkyl, morpholinoalkyl, cycloalkylaminoalkyl, hydroxyalkyl, Na, K, ½Ca, and ½Mg;

each R₅ is independently selected from the group consisting H, C₁-C₂₀ alkyl, C₅-C₇ cycloalkyl, C₇-C₂₀ alkylaryl, C₇-C₂₀ arylalkyl, substituted alkyl, aminoalkyl, alkylaminoalkyl, dialkylaminoalkyl, piperidinoalkyl, morpholinoalkyl, cycloalkylaminoalkyl and hydroxyalkyl

wherein

each x is from 0 to 5;

each y is from 1 to 5; and

(b) each R is selected from the group consisting of R₂, R_{c}, and

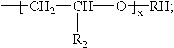

each R₂ is independently selected from the group consisting of H and C₁-C₄ alkyl;

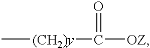

each R_{c} is

wherein each Z is independently selected from the group consisting of M, R₂, R_{c}, and R_{H},

each R_{H} is independently selected from the group consisting of C₅-C₂₀ alkyl, C₅-C₇ cycloalkyl, C₇-C₂₀ alkylaryl, C₇-C₂₀ arylalkyl, substituted alkyl, hydroxyalkyl, C₁-C₂₀ alkoxy-2-hydroxyalkyl, C₇-C₂₀ alkylaryloxy-2-hydroxyalkyl, (R₄)₂N-alkyl, (R₄)₂N-2-hydroxyalkyl, (R₄)₃ N-alkyl, (R₄)₃ N-2-hydroxyalkyl, C₆-C₁₂aryloxy-2-hydroxyalkyl,

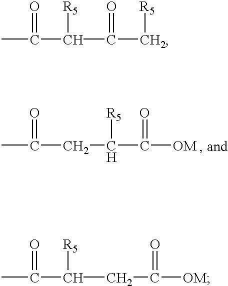

each R4 is independently selected from the group consisting of H, C₁-C₂₀ alkyl, C₅-C₇ cycloalkyl, C₇-C₂₀ alkylaryl, C₇-C₂₀ arylalkyl, aminoalkyl, alkylaminoalkyl, dialkylaminoalkyl, piperidinoalkyl, morpholinoalkyl, cycloalkylaminoalkyl and hydroxyalkyl;

each R₅ is independently selected from the group consisting of H, C₁-C₂₀ alkyl, C₅-C₇ cycloalkyl, C₇-C₂₀ alkylaryl, C₇-C₂₀ arylalkyl, substituted alkyl, hydroxyalkyl, (R₄)₂N-alkyl, and (R₄)₃ N-alkyl;

wherein:

M is a suitable cation selected from the group consisting of Na, K, ½Ca, and ½Mg;

each x is from 0 to 5;

each y is from 1 to 5.

The R groups defined above for all these cellulosic structures are typically groups which can hydrolyse or undergo some other chemical change in a wash liquor to aid deposition on a substrate.

Preferred molecular weight ranges are typically from 5,000 to 2,000,000, more preferably from 10,000 to 1,000,000.

Preferred degrees of substitution of the R groups are from 0.4 to 3, more preferably from 0.4 to 1, still more preferably from 0.5 to 0.75, especially from 0.6 to 0.7

Deposition aids with benefit groups attached are typically cellulosic strucures of the kind defined above for the fibre rebuild agents, but wherein at least one substituent R is a group having the function or structure of at least one of the auxiliaries described herein. In that case, the preferred average degree of substitution of R groups which undergo a chemical change to aid deposition is from 0.1 to 3, preferably from 0.1 to 1. Optionally, groups which are neither chemical change deposition aid groups, nor benefit agent groups may also be present, e.g. up to 65%, but preferably no more than 10% of the total number of substituent groups. The overall degree of substitution of all groups is preferably from 0.4 to 3, more preferably from 0.4 to 1, still more preferably from 0.5 to 0.75, especially from 0.6 to 0.7. Although benefit agent groups are preferably attached by an ester linkage, this is not mandatory.

(f) Anti-Redeposition Agents

When the auxiliary comprises an antiredeposition agent it may for example be selected from sodium carboxymethyl cellulose, cellulose ethers and mixtures thereof. Also preferred are the polycarboxylate polymers, especially acrylic and acrylic/maleic polymers, which incidentally also function as detergency builders, heavy metal sequestrants and powder structurants. Examples include polyacrylates, and acrylate/maleate copolymers such as Sokalan (Trade Mark) CP5 and CP45 ex BASF and the Acusol (Trade Mark) polymers ex Rohm & Haas. Mixtures of two or more the foregoing may be used.

When present, the total amount of anti-redeposition agent is from 0.04% to 40%, preferably from 0.4% to 25% by weight of such agents plus the polymer.

(g) Anti-Crease/Ironing Aids

Preferred anti-crease and ironing aids are oils and are typically lubricants such as silicone well known in the art.

When present, the total amount of all anti-crease and ironing aids is from 0.4% to 40%, preferably from 0.4% to 25% by weight of such aids plus the polymer.

(h) Enzymes

“Detersive enzyme”, as used herein, means any enzyme having a cleaning, stain removing or otherwise beneficial effect in a laundry or other cleaning application. Enzymes are included in the present detergent compositions for a variety of purposes, including removal of protein-based, saccharide-based, or triglyceride-based stains, for the prevention of refugee dye transfer, and for fabric restoration. Suitable enzymes include proteases, amylases, lipases, cellulases, peroxidases, and mixtures thereof of any suitable origin, such as vegetable, animal, bacterial, fungal and yeast origin. Preferred selections are influenced by factors such as pH-activity and/or stability optima, thermostability, and stability to active detergents, builders and the like. In this respect bacterial or fungal enzymes are preferred, such as bacterial amylases and proteases, and fungal cellulases.

Enzymes are normally incorporated into detergent or detergent additive compositions at levels sufficient to provide a “cleaning-effective amount”. The term “cleaning effective amount” refers to any amount capable of producing a cleaning, stain removal, soil removal, whitening, deodorizing, or freshness improving effect on substrates such as fabrics. In practical terms for current commercial preparations The polymer herein will typically comprise from 0.4% to 25%, preferably from 0.05% to 10% by weight of total commercial enzyme preparation relative to the total weight of the water soluble polymer and enzyme.

Proteolyte Enzymes

Endopeptidases (proteolytic enzymes or proteases) of various qualities and origins and having activity in various pH ranges of from 4-12 are available and can be used in the instant invention. Examples of suitable proteolytic enzymes are the subtilisins, which can be obtained from particular strains of B. subtilis, B. lentus, B. amyloliquefaciens and B. licheniformis, such as the commercially available subtilisins Savinase™, Alcalase™, Relase™, Kannase™ and Everlase™ as supplied by Novo Industri A/S, Copenhagen, Denmark or Purafect™, PurafectOxP™ and Properase™ as supplied by Genencor International. Chemically or genetically modified variants of these enzymes are included such as described in WO-A-99/02632 pages 12 to 16 and in WO-A-99/20727 and also variants with reduced allergenicity as described in WO-A-99/00489 and WO-A-99/49056.

Protease enzymes may be present in such commercial preparations at levels sufficient to provide from 0.005 to 0.1 Anson units (AU) of activity per gram of composition. It should be understood that the protease is present in the liquid detergent composition in a dissolved or dispersed form, i.e., the protease is not encapsulated to prevent the protease from the liquid composition. Instead the protease in more or less in direct contact with the liquid composition.

Protease enzymes are usually present in such commercial preparations at levels sufficient to provide from 0.005 to 0.1 Anson units (AU) of activity per gram of composition.

Suitable examples of proteases are the subtilisins which are obtained from particular strains of B. subtilis and B. licheniformis. One suitable protease is obtained from a strain of Bacillus, having maximum activity throughout the pH range of 8-12, developed and sold as ESPERASE™ by Novo Industries A/S of Denmark, hereinafter “Novo”. The preparation of this enzyme and analogous enzymes is described in GB 1,243,784 to Novo. Other suitable proteases include ALCALASE™ and SAVINASE™ from Novo and MAXATASE™ from International Bio-Synthetics, Inc., The Netherlands; as well as Protease A as disclosed in EP 130,756 A, and Protease B as disclosed in EP 303,761 A and EP 130,756 A. See also a high pH protease from Bacillus sp. NCIMB 40338 described in WO 9318140 A to Novo. Enzymatic detergents comprising protease, one or more other enzymes, and a reversible protease inhibitor are described in WO 9203529 A. Other preferred proteases include those of WO 9510591 A. When desired, a protease having decreased adsorption and increased hydrolysis is available as described in WO 9507791. A recombinant trypsin-like protease for detergents suitable herein is described in WO 9425583.

Useful proteases are also described in PCT publications: WO 95/30010, WO 95/30011, WO 95/29979.

Preferred proteolytic enzymes are also modified bacterial serine proteases, such as those described in EP-A-251446 (particularly pages 17, 24 and 98), and which is called herein “Protease B”, and in EP-A- 199404, which refers to a modified bacterial serine proteolytic enzyme which is called “Protease A” herein, Protease A as disclosed in EP-A-130756.

The amount of protease enzyme (if present) in the film may be at least 0.001% by weight, of a protease enzyme. Typical amounts are up to about 5 mg by weight, more typically 0.01 mg to 3 mg, of active enzyme per gram of the detergent composition. Stated otherwise, the film may comprise from 0.001% to 5%, preferably 0.01%-1% by weight of a commercial enzyme preparation. Typically, the proteolytic enzyme content is up to 0.2%, preferably from 4×10⁻⁵% to 0.06% by weight of the composition of pure enzyme.

Other Enzymes

The compositions of the invention may optionally contain one or more other enzymes. For example, they may contain 10-20,000 LU per gram of the detergent composition of a lipolytic enzyme selected from the group consisting of Lipolase, Lipolase ultra, LipoPrime, Lipomax, Liposam, and lipase from Rhizomucor miehei (e.g. as described in EP-A-238 023 (Novo Nordisk).

The enzymatic detergent compositions of the invention further comprise 10-20,000 LU per gram, and preferably 50-2,000 LU per gram of the detergent composition, of an lipolytic enzyme. In this specification LU or lipase units are defined as they are in EP-A-258 068 (Novo Nordisk).

A further method of assessing the enzymatic activity is by measuring the reflectance at 460 nm according to standard techniques.

Suitable other enzymes for use in the compositions of the invention can be found in the enzyme classes of the esterases and lipases, (EC 3.1.1.*, wherein the asterisk denotes any number).

A characteristic feature of lipases is that they exhibit interfacial activation. This means that the enzyme activity is much higher on a substrate which has formed interfaces or micelles, than on fully dissolved substrate. Interface activation is reflected in a sudden increase in lipolytic activity when the substrate concentration is raised above the critical micel concentration (CMC) of the substrate, and interfaces are formed. Experimentally this phenomenon can be observed as a discontinuity in the graph of enzyme activity versus substrate concentration. Contrary to lipases, however, cutinases do not exhibit any substantial interfacial activation.

Suitable lipase enzymes for detergent usage include those produced by microorganisms of the Pseudomonas group, such as Pseudomonas stutzeri ATCC 19.154, as disclosed in GB 1,372,034. See also lipases in Japanese Patent Application 53,20487. This lipase is available from Amano Pharmaceutical Co. Ltd., Nagoya, Japan, under the trade name Lipase P “Amano,” or “Amano-P.” Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. LIPOLASE™ enzyme derived from Humicola lanyginosa and commercially available from Novo, see also EP 341,947, is a preferred lipase for use herein. Lipase and amylase variants stabilized against peroxidase enzymes are described in WO 9414951 A to Novo. See also WO 9205249. Cutinase enzymes suitable for use herein are described in WO 8809367 A to Genencor.

Because of this characteristic feature, i.e. the absence of interfacial activation, we define for the purpose of this patent application Cutinases as lipolytic enzymes which exhibit substantially no interfacial activation. Cutinases therefor differ from classical lipases in that they do not possess a helical lid covering the catalytic binding site. Cutinases belong to a different subclass of enzymes (EC 3.1.1.50) and are regarded to be outside the scope of the present invention.

Of main interest for the present invention are fungal lipases, such as those from Humicola lanuginosa and Rhizomucor miehei. Particularly suitable for the present invention is the lipase from Humicola lanuginosa strain DSM 4109, which is described in EP-A-305 216 (Novo Nordisk), and which is commercially available as Lipolase (TM). Also suitable ar variants of this enzyme, such as described in WO-A-92/05249, WO-A-94/25577, WO-A-95/22615, WO-A-97/04079, WO-A-97/07202, WO-A-99/42566, WO-A-00/60063. Especially preferred is the variant D96L which is commercially available from Novozymes as Lipolase ultra, and the variant which is sold by Novozymes under the trade name LipoPrime.

The lipolytic enzyme of the present invention can usefully be added to the detergent composition in any suitable form, i.e. the form of a granular composition, a slurry of the enzyme, or with carrier material (e.g. as in EP-A-258 068 and the Savinase (TM) and Lipolase (TM) products of Novozymes). A good way of adding the enzyme to a liquid detergent product is in the form of a slurry containing 0.5 to 50% by weight of the enzyme in a ethoxylated alcohol nonionic surfactant, such as described in EP-A-450 702 (Unilever).

The enzyme to be used in the detergent compositions according to the invention can be produced by cloning the gene for the enzyme into a suitable production organism, such as Bacilli, or Pseudomonaceae, yeasts, such as Saccharomyces, Kluyveromyces, Hansenula or Pichia, or fungi like Aspergillus. The preferred production organism is Aspergillus with especial preference for Aspergillus oryzae.

Other optional suitable enzymes which may be included alone or in combination with any other enzyme may, for example, be oxidoreductases, transferases, hydrolases, lyases, isomerases and ligases. Suitable members of these enzyme classes are described in Enzyme nomenclature 1992: recommendations of the Nomenclature Committee of the International Union of Biochemistry and Molecular Biology on the nomenclature and classification of enzymes, 1992, ISBN 0-12-227165-3, Academic Press. The most recent information on the nomenclature of enzymes is available on the Internet through the ExPASy WWW server (http://www.expasy.ch/).

Examples of the hydrolases are carboxylic ester hydrolase, thiolester hydrolase, phosphoric monoester hydrolase, and phosphoric diester hydrolase which act on the ester bond; glycosidase which acts on O-glycosyl compounds; glycosylase hydrolysing N-glycosyl compounds; thioether hydrolase which acts on the ether bond; and exopeptidases and endopeptidases which act on the peptide bond. Preferable among them are carboxylic ester hydrolase, glycosidase and exo- and endopeptidases. Specific examples of suitable hydrolases include (1) exopeptidases such as aminopeptidase and carboxypeptidase A and B and endopeptidases such as pepsin, pepsin B, chymosin, trypsin, chymotrypsin, elastase, enteropeptidase, cathepsin B, papain, chymopapain, ficain, thrombin, plasmin, renin, subtilisin, aspergillopepsin, collagenase, clostripain, kallikrein, gastricsin, cathepsin D, bromelain, chymotrypsin C, urokinase, cucumisin, oryzin, proteinase K, thermomycolin, thermitase, lactocepin, thermolysin, bacillolysin. Preferred among them is subtilisin; (2) glycosidases such as α-amylase, β-amylase, glucoamylase, isoamylase, cellulase, endo-1,3(4)-β-glucanase (β-glucanase), xylanase, dextranase, polygalacturonase (pectinase), lysozyme, invertase, hyaluronidase, pullulanase, neopullulanase, chitinase, arabinosidase, exocellobiohydrolase, hexosaminidase, mycodextranase, endo-1,4-β-mannanase (hemicellulase), xyloglucanase, endo-β-galactosidase (keratanase), mannanase and other saccharide gum degrading enzymes as described in WO-A-99/09127. Preferred among them are α-amylase and cellulase; (3) carboxylic ester hydrolase including carboxylesterase, lipase, phospholipase, pectinesterase, cholesterol esterase, chlorophyllase, tannase and wax-ester hydrolase.

Examples of transferases and ligases are glutathione S-transferase and acid-thiol ligase as described in WO-A-98/59028 and xyloglycan endotransglycosylase as described in WO-A-98/38288.

Examples of lyases are hyaluronate lyase, pectate lyase, chondroitinase, pectin lyase, alginase II. Especially preferred is pectolyase, which is a mixture of pectinase and pectin lyase.

Examples of the oxidoreductases are oxidases such as glucose oxidase, methanol oxidase, bilirubin oxidase, catechol oxidase, laccase, peroxidases such as ligninase and those described in WO-A-97/31090, monooxygenase, dioxygenase such as lipoxygenase and other oxygenases as described in WO-A-99/02632, WO-A-99/02638, WO-A-99/02639 and the cytochrome based enzymatic bleaching systems described in WO-A-99/02641.

Peroxidase enzymes may be used in combination with oxygen sources, e.g., percarbonate, perborate, hydrogen peroxide, etc., for “solution bleaching” or prevention of transfer of dyes or pigments removed from substrates during the wash to other substrates present in the wash solution. Known peroxidases include horseradish peroxidase, ligninase, and haloperoxidases such as chloro- or bromo- peroxidase.

Peroxidase-containing detergent compositions are disclosed in WO 89099813 A, Oct. 19, 1989 to Novo and WO 8909813 A to Novo.

A range of enzyme materials and means for their incorporation into synthetic detergent compositions is also disclosed in WO 9307263 A and WO 9307260 A to Genencor International, WO 8908694 A to Novo, and U.S. Pat. No. 3,553,139, Jan. 5, 1971 to McCarty et al.

A process for enhancing the efficacy of the bleaching action of oxidoreductases is by targeting them to stains by using antibodies or antibody fragments as described in WO-A-98/56885. Antibodies can also be added to control enzyme activity as described in WO-A-98/06812.

A preferred combination is a detergent composition comprising of a mixture of the protease of the invention and conventional detergent enzymes such as lipose, amylase and/or cellulase together with one or more plant cell wall degrading enzymes.

Suitable amylases include those of bacterial or fungal origin. Chemically or genetically modified variants of these enzymes are included as described in WO-A-99/02632 pages 18, 19. Commercial cellulase are sold under the tradename Purastar™, Purastar OxAm™ (formerly Purafact Ox Am™) by Genencor; Termamyl™, Fungamyl™, Duramyl™, Natalase™, all available from Novozymes.

Amylases suitable herein include, for example, alfa-amylases described in GB 1,296,839 to Novo; RAPIDASE™, International Bio-Synthetics, Inc. and TERMAMYL™, Novo. FUNGAMYL™ from Novo is especially useful.

See, for example, references disclosed in WO 9402597. Stability-enhanced amylases can be obtained from Novo or from Genencor International. One class of highly preferred amylases herein have the commonality of being derived using site- directed mutagenesis from one or more of the Baccillus amylases, especialy the Bacillus cc- amylases, regardless of whether one, two or multiple amylase strains are the immediate precursors.

Oxidative stability-enhanced amylases vs. the above-identified reference amylase are preferred for use, especially in bleaching, more preferably oxygen bleaching, as distinct from chlorine bleaching, detergent compositions herein. Such preferred amylases include (a) an amylase according to WO 9402597, known as TERMAMYL™,

Particularly preferred amylases herein include amylase variants having additional modification in the immediate parent as described in WO 9510603 A and are available from the assignee, Novo, as DURAMYL™. Other particularly preferred oxidative stability enhanced amylase include those described in WO 9418314 to Genencor International and WO 9402597 to Novo Or WO 9509909 A to Novo.

Suitable cellulases include those of bacterial or fungal origin. Chemically or genetically modified variants of these enzymes are included as described in WO-A-99/02632 page 17. Particularly useful cellulases are the endoglucanases such as the EGIII from Trichoderma longibrachiatum as described in WO-A-94/21801 and the E5 from Thermomonospora fusca as described in WO-A-97/20025. Endoglucanases may consist of a catalytic domain and a cellulose binding domain or a catalytic domain only. Preferred cellulolytic enzymes are sold under the tradename Carezyme™, Celluzyme™ and Endolase™ by Novo Nordisk A/S; Puradax™ is sold by Genencor and KAC™ is sold by Kao corporation, Japan.

Cellulases usable herein include both bacterial and fungal types, preferably having a pH optimum between 5 and 9.5. U.S. Pat. No. 4,435,307 discloses suitable fungal cellulases from Humicola insolens or Humicola strain DSM1800 or a cellulase 212-producing fungus belonging to the genus Aeromonas, and cellulase extracted from the hepatopancreas of a marine mollusk, Dolabella Auricula Solander. Suitable cellulases are also disclosed in GB-A-2.075.028; GB-A- 2.095.275 and DE-OS-2.247.832. CAREZYME™ (Novo) is especially useful. See also WO 9117243.

Detergent enzymes are usually incorporated in an amount of 0.00001% to 2%, and more preferably 0.001% to 0.5%, and even more preferably 0.01% to 0.2% in terms of pure enzyme protein by weight of the composition. Detergent enzymes are commonly employed in the form of granules made of crude enzyme alone or in combination with other components in the detergent composition. Granules of crude enzyme are used in such an amount that the pure enzyme is 0.001 to 50 weight percent in the granules. The granules are used in an amount of 0.002 to 20 and preferably 0.1 to 3 weight percent. Granular forms of detergent enzymes are known as Enzoguard™ granules, prills, marumes or T-granules. Granules can be formulated so as to contain an enzyme protecting agent (e.g. oxidation scavengers) and/or a dissolution retardant material. Other suitable forms of enzymes are liquid forms such as the “L” type liquids from Novo Nordisk, slurries of enzymes in nonionic surfactants such as the “SL” type sold by Novo Nordisk and microencapsulated enzymes marketed by Novo Nordisk under the tradename “LDP” and “CC”.

The enzymes can be added as separate single ingredients (prills, granulates, stabilised liquids, etc. containing one enzyme) or as mixtures of two or more enzymes (e.g. cogranulates). Enzymes in liquid detergents can be stabilised by various techniques as for example disclosed in U.S. Pat. No. 4,261,868 and U.S. Pat. No. 4,318,818.

The detergent compositions of the present invention may additionally comprise one or more biologically active peptides such as swollenin proteins, expansins, bacteriocins and peptides capable of binding to stains.

(i) Fungicides

Suitable fungicides include 6-acetoxy-2,4-dimethyl-m-dioxane, diiodomethyl-p-tolysulphone, 4,4-dimethyloxaolidine, hexahydro-1,3,5-tris(2-hydroxyethyl)-s-triazine, sodium dimethyidithiocarbamate, sodium 2-mercaptobenzothioazle, zinc dimethyidithiocarbamate, zinc 2-mercaptobenzothiazole, sodium 2-pyridinethiol-1-oxide, sodium 2-pyridinethiol-1-oxide and N-trichloromethylthio-4-cyclohexene-1,2-dicarboximide.

When present, the total amount of fungicide is from 0.04% to 25%, preferably from 0.05% to 10% by weight of total fungicide plus the polymer.

(i) Insect Repellents and Insecticides

Suitable insect repellents include N-alkyl neoalkanamides wherein the alkyl is of 1 to 4 carbon atoms and the neoalkanoyl moiety is of 7 to 14 carbon atoms preferably N-methyl neodecanamide; N,N-diethyl meta toluamide (DEET), 2-Hydroxyethyl-n-octyl sulphide (MGK 874); N-Octyl bicycloheptene dicarboximide (MGK 264); hexahydrodibenzofuran (MGK 11), Di-n-propyl isocinchomerate (MGK 326); 2-Ethyl-1,3-hexanediol, 2-(n-butyl)-2-ethyl-1,3-propanediol, dimethyl phthalate, dibutyl succinate, piperonyl butoxide, pyrethrum, Cornmint, Peppermint, American spearmint, Scotch spearmint, Lemon oil, Citronella, cedarwood oil, pine oil, Limonene, carvone, Eucalyptol, Linalool, Gum Camphor, terpineol and fencholic acid.

When present, the total amount of insect repellent plus insecticide is from 0.04% to 25%, preferably from 0.05% to 10% by weight of total repellant plus the polymer.

### V. Compositions

When the polymer is used in film form to encapsulate a cleaning composition, that composition may be in powdered form or in liquid form. When it is in liquid form, it is preferably a substantially non-aqueous liquid composition

Typical primary components which are incorporated in solid from (e.g. powder or tablet will first be described. Then typical formulation components for substantially non-aqueous liquid detergent compositions will be described separately.

### (i) Solids

(a) Surfactants

In the most general sense, surfactants may be chosen from one or more of soap and non-soap anionic, cationic, nonionic. amphoteric and zwitterionic surface-active compounds and mixtures thereof. Many suitable surface-active compounds are available and are fully described in the literature, for example, in “Surface-Active Agents and Detergents”, Volumes I and II, by Schwartz, Perry and Berch.

For those compositions intended as laundry wash products, preferably, the surfactant(s) is/are selected from one or more soaps and synthetic non-soap anionic and non-ionic compounds. Detergent compositions suitable for use in most automatic fabric washing machines generally contain anionic non-soap surfactant, or non-ionic surfactant, or combinations of the two in any suitable ratio, optionally together with soap.

For example, laundry wash compositions of the invention may contain linear alkylbenzene sulphonate anionic surfactants, particularly linear alkylbenzene sulphonates having an alkyl chain length of C₈-C₁₅. It is preferred if the level of linear alkylbenzene sulphonate is from 0 wt % to 30 wt %, more preferably 1 wt % to 25 wt %, most preferably from 2 wt % to 15 wt %.

The laundry wash compositions of the invention may additionally or alternatively contain one or more other anionic surfactants in total amounts corresponding to percentages quoted above for alkyl benzene sulphonates. Suitable anionic surfactants are well-known to those skilled in the art. These include primary and secondary alkyl sulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred. Some particular examples of such other anionic surfactants are:—

alkyl ester sulphonates of the formula R-CH(SO₃M)—COOR′, where R is a C₈-C₂₀, preferably C₁₀-C₁₆ alkyl radical, R′ is a C₁-C₆, preferably C₁-C₃ alkyl radical, and M is an alkaline cation (sodium, potassium, lithium), substituted or non-substituted ammonium (methyl, dimethyl, trimethyl, tetramethyl ammonium, dimethyl piperidinium, etc.) or a derivative of an alkanol amine (monoethanol amine, diethanol amine, triethanol amine, etc.);

alkyl sulphates of the formula ROSO₃M, where R is a C₅-C₂₄, preferably C₁₀-C₁₈ alkyl or hydroxyalkyl radical, and M is a hydrogen atom or a cation as defined above, and their ethyleneoxy (EO) and/or propyleneoxy (PO) derivatives, having on average 0.5 to 30, preferably 0.5 to 10 EO and/or PO units;

alkyl amide sulphates of the formula RCONHR′OSO₃M, where R is a C₂-C₂₂, preferably C₆-C₂₀ alkyl radical, R′ is a C₂-C₃ alkyl radical, and M is a hydrogen atom or a cation as defined above, and their ethyleneoxy (EO) and/or propyleneoxy (PO) derivatives, having on average 0.5 to 60 EO and/or PO units;

the salts of C₈-C₂₄, preferably C₁₄-C₂₀ saturated or unsaturated fatty acids, C₈-C₂₂ primary or secondary alkyl sulphonates, alkyl glycerol sulphonates, the sulphonated polycarboxylic acids described in GB-A-1 082 179, paraffin sulphonates, N-acyl,N′-alkyl taurates, alkyl phosphates, isethionates, alkyl succinamates, alkyl sulphosuccinates, monoesters or diesters of sulphosuccinates, N-acyl sarcosinates, alkyl glycoside sulphates, polyethoxycarboxylates, the cation being an alkali metal (sodium, potassium, lithium), a substituted or non-substituted ammonium residue (methyl, dimethyl, trimethyl, tetramethyl ammonium, dimethyl piperidinium, etc.) or a derivative of an alkanol amine (monoethanol amine, diethanol amine, triethanol amine, etc.);

sophorolipids, such as those in acid or lactone form, derived from 17-hydroxyoctadecenic acid;

The laundry wash compositions of the invention may contain non-ionic surfactant. Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Some particular examples of such nonionic surfactants are:—

polyalkoxylenated alkyl phenols (i.e. polyethyleneoxy, polypropyleneoxy, polybutyleneoxy), the alkyl substituent of which has from 6 to 12 C atoms and contains from 5 to 25 alkoxylenated units; examples are TRITON X-45, X-114, X-100 and X-102 marketed by Rohm & Haas Co., IGEPAL NP2 to NP17 made by Rhodia;

C₈-C₂₂ polyalkoxylenated aliphatic alcohols containing 1 to 25 alkoxylenated (ethyleneoxy, propyleneoxy) units; examples are TERGITOL 15-S-9, TERGITOL 24-L-6 NMW marketed by Union Carbide Corp., NEODOL 45-9, NEODOL 23-65, NEODOL 45-7, NEODOL 45-4 marketed by Shell Chemical Co., KYRO EOB marketed by The Procter & Gamble Co., SYNPERONIC A3 to A9 made by ICI, RHODASURF IT, DB and B made by Rhodia;

the products resulting from the condensation of ethylene oxide or propylene oxide with propylene glycol, ethylene glycol, with a molecular weight in the order of 2000 to 10,000, such as the PLURONIC products marketed by BASF;

the products resulting from the condensation of ethylene oxide or propylene oxide with ethylene diamine, such as the TETRONIC products marketed by BASF;

C₈-C₁₈ ethoxyl and/or propoxyl fatty acids containing 5 to 25 ethyleneoxy and/or propyleneoxy units;

C₈-C₂₀ fatty acid amides containing 5 to 30 ethyleneoxy units;

ethoxylated amines containing 5 to 30 ethyleneoxy units;

alkoxylated amidoamines containing 1 to 50, preferably 1 to 25 and in particular 2 to 20 alkyleneoxy (preferably ethyleneoxy) units;

amine oxides such as the oxides of alkyl C₁₀-C₁₈ dimethylamines, the oxides of alkoxy C₈-C₂₂ ethyl dihydroxy ethylamines;

alkoxylated terpene hydrocarbons such as ethoxylated and/or propoxylated a- or b-pinenes, containing 1 to 30 ethyleneoxy and/or propyleneoxy units;

alkylpolyglycosides obtainable by condensation (for example by acid catalysis) of glucose with primary fatty alcohols (e.g. U.S. Pat. No. 3,598,865; U.S. Pat. No. 4,565,647; EP-A-132 043; EP-A-132 046) having a C₄-C₂₀, preferably C₈-C₁₈ alkyl group and an average number of glucose units in the order of 0.5 to 3, preferably in the order of 1.1 to 1.8 per mole of alkylpolyglycoside (APG), particularly those having

a C₈-C₁₄ alkyl group and on average 1.4 glucose units per mole

a C₁₂-C₁₄ alkyl group and on average 1.4 glucose units per mole

a C₈-C₁₄ alkyl group and on average 1.5 glucose units per mole

a C₈-C₁₀ alkyl group and on average 1.6 glucose units per mole

marketed under the names GLUCOPON 600 EC®, GLUCOPON 600 CSUP®, GLUCOPON 650 EC® and GLUCOPON 225 CSUP® respectively and made by HENKEL;

It is preferred if the level of total non-ionic surfactant is from 0 wt % to 30 wt %, preferably from 1 wt % to 25 wt %, most preferably from 2 wt % to 15 wt %.

Another class of suitable surfactants comprises certain mono-long chain-alkyl cationic surfactants for use in main-wash laundry compositions according to the invention. Cationic surfactants of this type include quaternary ammonium salts of the general formula R₁R₂R₃R₄N⁺ X⁻ wherein the R groups are long or short hydrocarbon chains, typically alkyl, hydroxyalkyl or ethoxylated alkyl groups, and X is a counter-ion (for example, compounds in which R₁ is a C₈₋C₂₂ alkyl group, preferably a C₈-C₁₀ or C₁₂-C₁₄ alkyl group, R₂ is a methyl group, and R₃ an R₄, which may be the same or different, are methyl or hydroxyethyl groups); and cationic esters (for example, choline esters).

The choice of surface-active compound (surfactant), and the amount present in the laundry wash compositions according to the invention, will depend on the intended use of the detergent composition. In fabric washing compositions, different surfactant systems may be chosen, as is well known to the skilled formulator, for handwashing products and for products intended for use in different types of washing machine. The total amount of surfactant present will also depend on the intended end use and may be as high as 60 wt %, for example, in a composition for washing fabrics by hand. In compositions for machine washing of fabrics, an amount of from 5 to 40 wt % is generally appropriate. Typically the compositions will comprise at least 2 wt % surfactant e.g. 2-60%, preferably 15-40% most preferably 25-35%.

In the case of laundry rinse compositions according to the invention the surfactant(s) is/are preferably selected from fabric conditioning agents. In fact, conventional fabric conditioning agent may be used. These conditioning agents may be cationic or non-ionic. If the fabric conditioning compound is to be employed in a main wash detergent composition the compound will typically be non-ionic. If used in the rinse phase, they will typically be cationic.

They may for example be used in amounts from 0.5% to 35%, preferably from 1% to 30% more preferably from 3% to 25% by weight of the composition.

Preferably the fabric conditioning agent(s) have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric conditioning agents are predominantly linear.

The fabric conditioning agents are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers, D Marsh, CRC Press, Boca Raton, Fla., 1990 (pages 137 and 337).

Substantially insoluble fabric conditioning compounds in the context of this invention are defined as fabric conditioning compounds having a solubility less than 1×10⁻³ wt % in deminerailised water at 20° C. Preferably the fabric softening compounds have a solubility less than 1×10⁻⁴ wt %, most preferably less than 1×10⁻⁸ to 1×10⁻⁶. Preferred cationic fabric softening agents comprise a substantially water insoluble quaternary ammonium material comprising a single alkyl or alkenyl long chain having an average chain length greater than or equal to C₂₀ or, more preferably, a compound comprising a polar head group and two alkyl or alkenyl chains having an average chain length greater than or equal to C₁₄.

Preferably, the cationic fabric softening agent is a quaternary ammonium material or a quaternary ammonium material containing at least one ester group. The quaternary ammonium compounds containing at least one ester group are referred to herein as ester-linked quaternary ammonium compounds.

As used in the context of the quarternary ammonium cationic fabric softening agents, the term ‘ester group’, includes an ester group which is a linking group in the molecule.

It is preferred for the ester-linked quaternary ammonium compounds to contain two or more ester groups. In both monoester and the diester quaternary ammonium compounds it is preferred if the ester group(s) is a linking group between the nitrogen atom and an alkyl group. The ester groups(s) are preferably attached to the nitrogen atom via another hydrocarbyl group.

Also preferred are quaternary ammonium compounds containing at least one ester group, preferably two, wherein at least one higher molecular weight group containing at least one ester group and two or three lower molecular weight groups are linked to a common nitrogen atom to produce a cation and wherein the electrically balancing anion is a halide, acetate or lower alkosulphate ion, such as chloride or methosulphate. The higher molecular weight substituent on the nitrogen is preferably a higher alkyl group, containing 12 to 28, preferably 12 to 22, e.g. 12 to 20 carbon atoms, such as coco-alkyl, tallowalkyl, hydrogenated tallowalkyl or substituted higher alkyl, and the lower molecular weight substituents are preferably lower alkyl of 1 to 4 carbon atoms, such as methyl or ethyl, or substituted lower alkyl. One or more of the said lower molecular weight substituents may include an aryl moiety or may be replaced by an aryl, such as benzyl, phenyl or other suitable substituents.

Preferably the quaternary ammonium material is a compound having two C₁₂-C₂₂ alkyl or alkenyl groups connected to a quaternary ammonium head group via at least one ester link, preferably two ester links or a compound comprising a single long chain with an average chain length equal to or greater than C₂₀.

More preferably, the quaternary ammonium material comprises a compound having two long chain alkyl or alkenyl chains with an average chain length equal to or greater than C₁₄. Even more preferably each chain has an average chain length equal to or greater than C₁₆. Most preferably at least 50% of each long chain alkyl or alkenyl group has a chain length of C₁₈. It is preferred if the long chain alkyl or alkenyl groups are predominantly linear.

The most preferred type of ester-linked quaternary ammonium material that can be used in laundry rinse compositions according to the invention is represented by the formula (A):

OCOR²¹

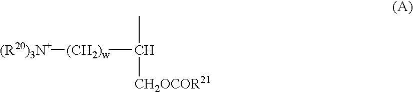

wherein each R²⁰ group is independently selected from C₁₋₄ alkyl, hydroxyalkyl or C₂₋₄ alkenyl groups; and wherein each R²¹ group is independently selected from C₈₋₂₈ alkyl or alkenyl groups; Y⁻ is any suitable counter-ion, i.e. a halide, acetate or lower alkosulphate ion, such as chloride or methosulphate; and

w is an integer from 1-5 or is 0

It is especially preferred that each R²⁰ group is methyl and each w is 2.

It is advantageous for environmental reasons if the quaternary ammonium material is biologically degradable.

Preferred materials of this class such as 1,2 bis[hardened tallowoyloxy]-3-trimethylammonium propane chloride and their method of preparation are, for example, described in U.S. Pat. No. 4,137,180. Preferably these materials comprise small amounts of the corresponding monoester as described in U.S. Pat. No. 4,137,180 for example 1-hardened tallow-oyloxy-2-hydroxy-3-trimethylammonium propane chloride.

Another class of preferred ester-linked quaternary ammonium materials for use in laundry rinse compositions according to the invention can be represented by the formula:

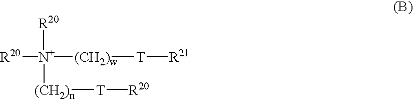

wherein T is

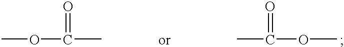

and

wherein R²⁰, R²¹, w, and Y⁻ are as defined above.

Of the compounds of formula (B), di-(tallowyloxyethyl)-dimethyl ammonium chloride, available from Hoechst, is the most preferred. Di-(hardened tallowyloxyethyl)dimethyl ammonium chloride, ex Hoechst and di-(tallowyloxyethyl)-methyl hydroxyethyl methosulphate are also preferred.

Another preferred class of quaternary ammonium cationic fabric softening agent is defined by formula (C):—

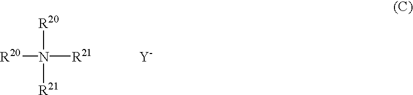

where R²⁰, R²¹ and Y⁻ are as hereinbefore defined.

A preferred material of formula (C) is di-hardened tallow-diethyl ammonium chloride, sold under the Trademark Arquad 2HT.

The optionally ester-linked quaternary ammonium material may contain optional additional components, as known in the art, in particular, low molecular weight solvents, for instance isopropanol and/or ethanol, and co-actives such as nonionic softeners, for example fatty acid or sorbitan esters.

Detergency Builders

The compositions of the invention, when used as laundry wash compositions, will generally also contain one or more detergency builders. The total amount of detergency builder in the compositions will typically range from 5 to 80 wt %, preferably from 10 to 60 wt %.

Inorganic builders that may be present include sodium carbonate, if desired in combination with a crystallisation seed for calcium carbonate, as disclosed in GB 1 437 950 (Unilever); crystalline and amorphous aluminosilicates, for example, zeolites as disclosed in GB 1 473 201 (Henkel), amorphous aluminosilicates as disclosed in GB 1 473 202 (Henkel) and mixed crystalline/amorphous aluminosilicates as disclosed in GB 1 470 250 (Procter & Gamble); and layered silicates as disclosed in EP 164 514B (Hoechst). Inorganic phosphate builders, for example, sodium orthophosphate, pyrophosphate and tripolyphosphate are also suitable for use with this invention.

The compositions of the invention preferably contain an alkali metal, preferably sodium, aluminosilicate builder. Sodium aluminosilicates may generally be incorporated in amounts of from 10 to 70% by weight (anhydrous basis), preferably from 25 to 50 wt %.

The alkali metal aluminosilicate may be either crystalline or amorphous or mixtures thereof, having the general formula: 0.8-1.5 Na₂O. Al₂O₃.0.8-6 SiO₂.

These materials contain some bound water and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB 1 429 143 (Procter & Gamble). The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP 384 070A (Unilever). Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20.

Especially preferred is zeolite MAP having a silicon to aluminium ratio not exceeding 1.07, more preferably about 1.00. The calcium binding capacity of zeolite MAP is generally at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di and trisuccinates, carboxymethyloxy succinates, carboxymethyloxymalonates, dipicolinates, hydroxyethyliminodiacetates, alkyl- and alkenylmalonates and succinates; and sulphonated fatty acid salts. This list is not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form.

Bleaches

Laundry wash compositions according to the invention may also suitably contain a bleach system. Fabric washing compositions may desirably contain peroxy bleach compounds, for example, inorganic persalts or organic peroxyacids, capable of yielding hydrogen peroxide in aqueous solution.

Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate.

Especially preferred is sodium percarbonate having a protective coating against destabilisation by moisture. Sodium percarbonate having a protective coating comprising sodium metaborate and sodium silicate is disclosed in GB 2 123 044B (Kao).

The peroxy bleach compound is suitably present in an amount of from 0.1 to 35 wt %, preferably from 0.5 to 25 wt %. The peroxy bleach compound may be used in conjunction with a bleach activator (bleach precursor) to improve bleaching action at low wash temperatures. The bleach precursor is suitably present in an amount of from 0.1 to 8 wt %, preferably from 0.5 to 5 wt %.

Preferred bleach precursors are peroxycarboxylic acid precursors, more especially peracetic acid precursors and pernoanoic acid precursors. Especially preferred bleach precursors suitable for use in the present invention are N,N,N′,N′,-tetracetyl ethylenediamine (TAED) and sodium noanoyloxybenzene sulphonate (SNOBS). The novel quaternary ammonium and phosphonium bleach precursors disclosed in U.S. Pat. No. 4,751,015 and U.S. Pat. No. 4,818,426 (Lever Brothers Company) and EP 402 971A (Unilever), and the cationic bleach precursors disclosed in EP 284 292A and EP 303 520A (Kao) are also of interest.

The bleach system can be either supplemented with or replaced by a peroxyacid. examples of such peracids can be found in U.S. Pat. No. 4,686,063 and U.S. Pat. No. 5,397,501 (Unilever). A preferred example is the imido peroxycarboxylic class of peracids described in EP A 325 288, EP A 349 940, DE 382 3172 and EP 325 289. A particularly preferred example is phtalimido peroxy caproic acid (PAP). Such peracids are suitably present at 0.1-12%, preferably 0.5-10%.

A bleach stabiliser (transistor metal sequestrant) may also be present. Suitable bleach stabilisers include ethylenediamine tetra-acetate (EDTA), the polyphosphonates such as Dequest (Trade Mark) and non-phosphate stabilisers such as EDDS (ethylene diamine di-succinic acid). These bleach stabilisers are also useful for stain removal especially in products containing low levels of bleaching species or no bleaching species.

An especially preferred bleach system comprises a peroxy bleach compound (preferably sodium percarbonate optionally together with a bleach activator), and a transition metal bleach catalyst as described and claimed in EP 458 397A, EP 458 398A and EP 509 787A (Unilever).

### (ii) Liquids

A substantially non-aqueous liquid cleaning composition must contain at least one non-aqueous liquid. Further, the non-aqueous liquid itself and/or another component of the composition must provide a cleaning function when released into the wash liquor.

By “substantially non-aqueous” it is meant that that the amount of water in the liquid composition is below the level at which the package would dissolve through contact with its contents. Preferably, the liquid composition comprises 25%, e.g. no more than 20%, more preferably no more than about 15%, still more preferably no more from 10%, such as no more than about 7%, even more preferably no more than about 5% and most preferably no more than from about 3% to about 4%, by weight water. However, in some cases, it may be possible (whether by reason of the thickness of the film used, the physical properties, such as viscosity, of the liquid composition or otherwise) to use even higher quantities of water in the liquid composition inside the package according to the invention, although these should never exceed 50% by weight of the liquid composition.

The substantially non-aqueous liquid composition may be substantially Newtonion or else non-Newtonion in rheology. The latter especially applies when the composition comprises dispersed solids. Therefore, for the avoidance of doubt, all viscosities expressed herein are measured at a shear rate of 21s⁻¹.

The viscosity of the composition is preferably from 25 mPaS, 50 mPaS, 75 mPaS or 100 mPaS, preferably 125 mPaS, more preferably 150 mPaS to 10,000 mPaS, for example above 150 mPaS but no more than 10,000 mPaS. The alternative embodiment of the invention relates to VFFS encapsulation in which case, the minimum viscosity must be 150 mPaS, for example above 150 mPaS.

The composition may be considered as falling into the sub-classes of thin liquids, thick liquids, and gels/pastes.

The thin liquids may have a minimum viscosity of 25, 50, 75, 100, 125, 150 mPaS or above 150 mPaS for example 175 mPaS, preferably 200 mPaS. They may for example have a maximum viscosity of 500 mPaS preferably 450 mPaS more preferably 400 mPaS or even 250 mPaS.

The thick liquids may have a minimum viscosity of 400 mPaS, for example 350 mPaS, or even 300 mPaS and a maximum viscosity of 1,500 mPaS, preferably 1,200 mPaS.

The gels or pastes may have a minimum viscosity of 1,400 mPaS, for example 1,500 mPaS, preferably 1,750 mPaS, 2000 mPaS, 2,500 mPaS, 3,000 mPaS or even 3,500 mPaS. Their maximum viscosity may be 10,000 mPaS, preferably 9,000 mPaS, more preferably 8,000 mPaS, 7,500 mPaS or even 4,000 mPaS.

The non-aqueous liquid may comprise one or more non-aqueous liquid components. These may be one or more liquid surfactants and/or one or more non-aqueous non-surfactant liquids.

Suitable liquid surfactants liquid nonionic surfactants.

Nonionic detergent surfactants are well-known in the art. They normally consist of a water-solubilizing polyalkoxylene or a mono- or d-alkanolamide group in chemical combination with an organic hydrophobic group derived, for example, from alkylphenols in which the alkyl group contains from about 6 to about 12 carbon atoms, dialkylphenols in which primary, secondary or tertiary aliphatic alcohols (or alkyl-capped derivatives thereof), preferably having from 8 to 20 carbon atoms, monocarboxylic acids having from 10 to about 24 carbon atoms in the alkyl group and polyoxypropylense. Also common are fatty acid mono- and dialkanolamides in which the alkyl group of the fatty acidradical contains from 10 to about 20 carbon atoms and the alkyloyl group having from 1 to 3 carbon atoms. In any of the mono- and di-alkanolamide derivatives, optionally, there may be a polyoxyalkylene moiety joining the latter groups and the hydrophobic part of the molecule. In all polyalkoxylene containing surfactants, the polyalkoxylene moiety preferably consists of from 2 to 20 groups of ethylene oxide or of ethylene oxide and propylene oxide groups. Amongst the latter class, particularly preferred are those described in the applicants' published European specification EP-A-225,654, especially for use as all or part of the solvent. Also preferred are those ethoxylated nonionics which are the condensation products of fatty alcohols with from 9 to 15 carbon atoms condensed with from 3 to 11 moles of ethylene oxide. Examples of these are the condensation products of C₁₁₋₁₃ alcohols with (say) 3 or 7 moles of ethylene oxide. These may be used as the sole nonionic surfactants or in combination with those of the described in the last-mentioned European specification, especially as all or part of the solvent.

Another class of suitable nonionics comprise the alkyl polysaccharides (polyglycosides/oligosaccharides) such as described in any of specifications U.S. Pat. Nos. 3,640,998; 3,346,558; 4,223,129; EP-A-92,355; EP-A-99,183; EP 70,074, '75, '76, '77; EP 75,994, '95, '96.

Nonionic detergent surfactants normally have molecular weights of from about 300 to about 11,000. Mixtures of different nonionic detergent surfactants may also be used, provided the mixture is liquid at room temperature.

Suitable non-aqueous non-surfactant liquids forms can be used alone or with in combination with liquid surfactants. Non-surfactant solvents which are more preferred category include ethers, polyethers, alkylamines and fatty amines, (especially di- and tri-alkyl- and/or fatty-N-substituted amines), alkyl (or fatty) amides and mono- and di- N-alkyl substituted derivatives thereof, alkyl (or fatty) carboxylic acid lower alkyl esters, ketones, aldehydes, polyols, and glycerides. Specific examples include respectively, di-alkyl ethers, polyethylene glycols, alkyl ketones (such as acetone) and glyceryl trialkylcarboxylates (such as glyceryl tri-acetate), glycerol, propylene glycol, and sorbitol.

Other suitable solvents are lower (C₁₋₄) alcohols, such as ethanol, or higher (C₅₋₉) alcohols, such as hexanol, as well as alkanes and olefins. However, they can be combined with other solvent materials which are surfactants and non-surfactants having the aforementioned “preferred” kinds of molecular structure. Even though they appear not to play a role in the deflocculation process, it is often desirable to include them for lowering the viscosity of the product and/or assisting soil removal during cleaning.

Preferably, the compositions of the invention contain the organic solvent (whether or not comprising liquid surfactant) in an amount of at least 10% by weight of the total composition. The amount of the solvent present in the composition may be as high as about 90%, but in most cases the practical amount will lie between 20 and 70% and sometimes, between 20 and 50% by weight of the composition. The weight ratio of surfactant to non-surfactant non-aqueous liquid components is preferably from 0:10 to 10:0, more preferably from 1:10 to 10:1, still more preferably from 1:6 to 6:1, yet more preferably from 1:5 to 5:1, eg. from 1:3 to 3:1.

Whether or not the composition contains nonionic surfactant, one or more other surfactants may be present. These may be in liquid form or as solid dissolved or dispersed in the substantially non-aqueous liquid component. They may be selected from anionic cationic and ampholytic detergent surfactants. The anionic surfactants may be incorporated in free acid and/or neutralised form. The cationic surfactant may be neutralised with a counter ion or it may be used as stabilising compound to neutralise the at least one ionic ingredient with an exchangeable hydrogen ion.

The composition may also comprise one or more solid dissolved and/or dispersed in the substantially non-aqueous liquid. When these are dispersed solids, it is preferred also to include one or more deflocculating agents as described in EP-A-0 266 199.

Some of these ingredients may be of an acidic nature, such as soaps or the acid precursors of anionic surfactants (which can be used for their surfactant properties and/or as deflocculants). These materials have an exchangeable hydrogen ion.

In the case where the polymer is a PVA copolymer having carboxylate functionality and when it encapsulates a substantially non-aqueous liquid cleaning composition, then a problem can arise when the composition comprises or includes, an ionic ingredient having exchangeable hydrogen ions, i.e. demonstrating acid-like character.

Specifically, when the copolymer film contains carboxylic acid or carboxylate groups (either of these hereinafter being referred to as “carboxylate functionality”) in proximity to hydroxyl groups on the same carbon chain and there is an attendant drive towards cyclisation of these groups by water elimination to form lactones. A low level of lactone formation is desirable to improve the mechanical properties of the film. However, the formation of excessive amounts of lactones is undesirable as this tends to reduce the cold water solubility of the film, giving rise to a danger of undissolved film residues when the package is used.

The problem of excessive lactone formation is particularly acute when the liquid composition inside the package comprises ionic species. This is thought to be because the presence of ionic species can give rise to exchange between sodium ions (associated with carboxylate groups) in the film and hydrogen ions in the liquid composition. Once such exchange has occurred, the resulting carboxylic acid group in the film can cyclise with a neighbouring hydroxyl group, eliminating water in the process, thus forming lactones.

This problem can be mitigated or solved by also including in the liquid composition, a molar excess (with respect to the amount of exchangeable hydrogen ions in the at least one ionic ingredient) of a stabilising compound effective for combining with the exchangeable hydrogen ions to hinder the formation of lactones, especially β lactones within the film. Actually, the amount of stabilising compounds can be as low as 95 mole % of the amount to completely neutralise the ionic ingredient, especially if the stabilising compound is or comprises an inorganic base and/or ammonium hydroxide.

The problem of excessive lactone formation is particularly acute when the liquid composition inside the package comprises ionic species having an exchangeable hydrogen ion, for example fatty acids or the acid precursors of anionic surfactants.

This problem may be solved by including in the composition, a stabilising compound effective for combining with the exchangeable hydrogen ions to hinder the formation of lactones within the film. This stabilising compound should preferably be in molar excess relative to the component(s) having an exchangeable ion. This molar excess is preferably up to 105 mole %, preferably up to 110 mole % of the stoichiometric amount necessary for complete neutralisation. It is preferably an organic base such as one or more amines, e.g. monoethanolamine, triethanolamine and mixtures thereof. In principle, and especially when the stabilising compound is or comprises an inorganic base such as an alkali metal (e.g. sodium or potassium) hydroxide, or ammonium hydroxide, it may, however, present in an amount as low as 95 mole %, eg. from 95 mole % to 105 mole % relative to the component(s) having an exchangeable hydrogen ion.

Other possible inorganic stabilising compounds are alkaline earth metal hydroxides or other inorganic bases which do liberate water on protonation. These are preferably also used in an amount indicated above for the alkali metal hydroxides and ammonium hydroxide.

Yet other suitable stabilising compounds are amines other than monoethanolamine and triethanolamine, and organic Lewis bases or other organic or inorganic bases provided that they will interact effectively with labile protons within the detergent composition to hinder the production of lactones in the film.

The Ionic Ingredient with Exchangeable Hydrogen Ions When present, the ionic ingredient with exchangeable hydrogen ions may, for example, constitute from between 1% and 40% (prior to any neutralisation) by weight of the total substantially non-aqueous liquid composition. When used primarily for their surfactant properties, such ingredients may for example be present in amounts greater than 10% by weight. When used as deflocculants (see below), the amounts may be 10% by weight or less, e.g. no more than 5% by weight. These ingredients may for example be selected from anionic surfactant acid precursors and fatty acids and mixtures thereof.

Anionic surfactant acids are well known to those skilled in the art. Examples suitable for use in a liquid composition according to the invention include alkylbenzene sulphonic acid, particularly C₈₋₁₅ linear alkylbenzene sulphonic acids and mixtures thereof. Other suitable surfactant acids include the acid forms of olefin sulphonates, alkyl ether sulphates, alkyl sulphates or alkane sulphonates and mixtures thereof.

A wide range of fatty acids are suitable for inclusion in a liquid composition according to the invention, for example selected from one or more C₈₋₂₄ alkyl or alkenyl monocarboxylic acids. Saturated or unsaturated fatty acids may be used. Examples of suitable fatty acids include oleic acid, lauric acid or hardened tallow fatty acid.

Unit Dose Volume

The amount of the substantially non-aqueous liquid cleaning composition is each unit dose envelope may for example be from 10 ml to 100 ml, e.g. from 12.5 ml to 75 ml, preferably from 15 ml to 60 ml, more preferably from 20 ml to 55 ml.

The invention will now be more particularly described with reference to the following examples.

### VI EXAMPLES

The present invention will now be explained in more detail by reference to the following non-limiting examples.

### Example 1

Synthesis of [(MeN4Py)FeCl]Cl

The ligand N,N-bis(pyridin-2-yl-methyl)-1,1-bis(pyridin-2-yl)-1-aminoethane (MeN4py) was prepared as described in EP 0 909 809 A2. The ligand MeN4Py (33.7 g; 88.5 mmoles) was dissolved in 500 ml dry methanol. Small portions of FeCl₂.4H₂O (0.95 eq; 16.7 g; 84.0 mmoles) were added, yielding a clear red solution. After addition, the solution was stirred for 30 minutes at room temperature, after which the methanol was removed (rotary-evaporator). The dry solid was ground and 150 ml of ethylacetate was added and the mixture was stirred until a fine red powder was obtained. This powder was washed twice with ethyl acetate, dried in the air and further dried under reduced pressure vacuum at 40° C. El. Anal. Calc. for [Fe(MeN4py)Cl]Cl.2H₂O: C 53.03; H 5.16; N 12.89; Cl 13.07; Fe 10.01%. Found C 52.29/52.03; H 5.05/5.03; N 12.55/12.61; Cl: 12.73/12.69; Fe: 10.06/10.01%.

### Example

(i) Unmodified PVA Film

To 50 gram of denim water was added: 2.0 gram glycerol, 0.10 gram Neodol 11-5, and 10 ml of ethanol. This mixture was heated to 70° Cf with stirring. To this mixture 10 gram PVA (Mowiol 26-88, ex Hoechst) was added slowly. After dissolution was complete the mixture was left to cool with stirring. Subsequently the mixture was poured in a tray of 16 by 38 cm and left to dry for 24 hours in the dark at ambient temperature. The film could easily be removed from the tray.

(ii) PVA Film & Bleach Catalyst

A slurry of 50 gram water, 10 gram PVA Mowiol 26-88, 2.0 gram glycerol and 10 ml ethanol was prepared as described above. To this 360 mg [(MeN4Py)FeCl]Cl+30 mg acetonitrile dissolved in 15 ml water was added. After mixing the slurry was poured in a tray and left to dry overnight, an orange film was obtained, containing 3% w/w [(MeN4Py)FeCl]Cl This film was tested on a tomato/oil stain in a wash using Formulation A (5g/l). The film containing [(MeN4Py)FeCl]Cl performed nearly as well as pure [(MeN4Py)FeCl]Cl.

Performance of [(MeN4Py)FeCl]Cl incorporated in PVA film

The test was carried out on tomato/oil stain.

Formulation A was dosed at 5 g/l, 24° FH, 30 min. wash at 40° C.

In all experiments [(MeN4Py)FeCl]Cl was dosed at μM, PVA film was dosed 0.05 g/l.

Experimental details:

Bottles 1,2: 25 ml Formulation A solution

Bottles 3,4: 25 ml Formulation A solution+37.5 μg [(MeN4Py)FeCl]Cl

Bottles 5,6: 25 ml Formulation A solution+1.25 mg “empty” PVA film

Bottles 7,8: 25 ml Formulation A solution+1.25 mg 3% w/w [(MeN4Py)FeCl]Cl PVA film.

Bottles 9,10: 25 ml water (24° FH)+37.5 μG [(MeN4Py)FeCl]Cl

Bottles 11,12: 25 ml Formulation A+37.5 μg [(MeN4Py)FeCl]Cl+1.25 mg unmodified PVA film.

Results:

| | | Delta R460 after | Delta R460 after |
|---|---|---|---|
| Bottles | Test | wash | 24 hrs. |
| 1, 2 | Formulation A | 7.86 | 12.5 |
| 3, 4 | Formulation A + | 13.0 | 22.0 |
| | [(MeN4Py)FeCl]Cl | | |
| 5, 6 | Formulation A + PVA | 6.89 | 7.94 |
| 7, 8 | Formulation A + | 11.7 | 18.9 |
| | [(MeN4Py)FeCl]Cl/PVA | | |
| 9, 10 | Water + | 13.0 | 27.1 |
| | [(MeN4Py)FeCl]Cl | | |
| 11, 12 | Formulation A + | 11.7 | 19.3 |
| | [(MeN4Py)FeCl]Cl + | | |
| | PVA | | |

### Example 3

PVA film containing 25% Polyvinylpyrrolidone was made of 10 gram PVA (Mowiol 26-88), 2.0 gram glycerol and 4.0 gram Polyvinylpyrrolidone (Mw 10,000). This material was tested for dye transfer inhibition using one 4 by 4 centimeter CN1 cloth (washed white cotton) and two 4 by 4 cm 0.03 CD/R cloths (1.5% Solophenyl Green BL dye on cotton) in a 25 ml wash at 40° C. for 30 minutes. The was liquor was made of 3.3 g/l Formulation A base (without enzymes, dye and perfume) in tap water, PVP was dosed as if it were present in 1% on formulation basis so 0.83 mg per bottle. The films were all dosed at 3.3 mg per bottle. For the PVP/PVA film (25%) this also results in 0.83 mg PVP. Delta is a good indication for green colour, the higher delta a the greener the white cloth has become. Delta E represents the overall colour change.

| Test | Delta a | Delta E |
|---|---|---|
| No PVP, no film | 6.2 | 7.8 |
| Pure PVP, no film | 0.74 | 1.9 |
| PVP/PVA film | 0.53 | 1.3 |
| PVA film, 74% hydrolyzed | 1.3 | 1.9 |
| PVA film, 88% hydrolysed | 1.4 | 2.1 |
| PVA film, 99% hydrolysed | 4.1 | 5.2 |
| PVA film, 88% + PVP | 0.6 | 1.6 |

Conclusions

PVP on its own gives dye transfer inhibition. When used incorporated in PVA film its performance is even slightly higher. This is because PVA film on its own also gives significant dye transfer inhibition. It was assumed that the acetate groups in PVA are responsible for this phenomenon. For this reason a film made of 99% hydrolysed PVA (Mowiol 28-99) was tested as well. The poor dye inhibition results of this 99% hydrolysed PVA shows that the acetate groups are preferred for dye transfer inhibition. An idea would now be to make the Formulation A film of a partly hydrolysed (e.g. 88%) PVA grade which will impart dye transfer inhibition in the absence of PVP leaving “space” for other minors.

Formulation A: 53.24 gram Neodol (C11E05), 11.0 gram monopropylene glycol, 42.7 gram glycerol, 15.12 gram monoethanolamine, 26.2 gram oleic acid, 41.7 gram LAS acid, 5.1 gram demi water.

1. A solid water soluble polymer having dispersed therein, at least one cleaning composition auxiliary.

2. A polymer according to claim 1, wherein the total amount of solid cleaning composition auxiliary is from 0.01% to 50%, preferably from 0.04% to 40%, more preferably from 0.4% to 25% by weight of the sum of the total weight of the polymer and the total weight of all solid auxiliary material.

3. A polymer according to claim 1, wherein said solid water soluble polymer is in the form of a film.

4. A polymer in the form of a film according to claim 1, formed into a capsule containing a detergent composition.

5. A polymer in the form of a polymer film capsule according to claim 1, wherein the cleaning composition is a substantially non-aqueous liquid detergent composition.

6. A polymer according to claim 1, wherein the solid water soluble polymer is in the form of a solid block or tablet.

7. A polymer in the form of a block or tablet according to claim 1, wherein said solid water soluble polymer also has dispersed therein at least one solid cleaning composition primary ingredient.

8. A polymer according to claim 1, wherein said solid cleaning composition primary ingredient is selected from one or more solid materials selected from surfactants, detergency builders and bleaches.

9. A polymer in the form of a block or tablet according to claim 1, wherein said block or tablet further encloses a solid decorative member.

10. A polymer according to claim 1, wherein the solid detergent composition auxiliary is selected from bleach catalysts, UV absorbers such as fluorescers and photofading inhibitors, for example sunscreens/UV inhibitors and/or anti-oxidants, materials for inhibiting fibre damage and/or for colour care and/or for crease reduction and/or for ease of ironing, enzymes, perfume, sequestrants, buffer agents, effervescent agents as well as fungicides, insect repellents and/or insecticides.
